(19) United States
(12) Patent Application Publication
(10) Pub. No.: US 2026/0289748 A1
(43) Pub. Date: Sep. 24, 2026

(54) SYSTEM

(71) Applicant: SoftBank Group Corp., Tokyo (JP)

(72) Inventor: Saya KATAFUCHI, Tokyo (JP)

(73) Assignee: SoftBank Group Corp., Tokyo (JP)

(21) Appl. No.: 19/562,840

(22) Filed: Mar. 11, 2026

(30) Foreign Application Priority Data
Mar. 19, 2025 (JP) 2025-044476

(51) Int. Cl. G06T 5/70; G06T 5/60

(52) U.S. Cl. CPC G06T 5/70; G06T 5/60

(57) ABSTRACT

A system includes a processor that is configured to receive a plurality of inputs from a user including character features and an idol's assigned color, create, based on the plurality of inputs, a prompt for instructing a generative AI model to generate an abstract image or a monogram, input the prompt to the generative AI model to cause the generative AI model to generate the abstract image or the monogram, apply an emotion analysis algorithm to analyze an emotion of the user, and adjust a color tone of the abstract image or the monogram to be generated, based on a result of the analysis.

### CROSS-REFERENCE TO RELATED APPLICATION

This application is based on and claims priority under 35 USC 119 from Japanese Patent Application No. 2025-044476 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating images or monograms based on user preferences typically rely only on simple inputs such as character names, keywords, or colors, and do not sufficiently reflect the user's emotional state or nuanced preferences in the generated results. As a result, the generated abstract images or monograms often lack a sense of emotional resonance with the user and may not adequately express the user's attachment to a favorite character or idol. Furthermore, existing systems generally do not provide integrated support for converting such generated images or monograms into concrete fan items, such as personalized “oshi” goods, nor do they offer output formats optimized for digital use, for example as icons for social networking services. Consequently, there is a need for a system that can: (i) accept detailed inputs regarding character features and idol-assigned colors, (ii) incorporate analysis of the user's emotional state into the generation process, and (iii) provide both practical guidance for creating fan items and suitable output formats for online use.

### SUMMARY

To solve the above-described problems, an aspect of the present invention provides a system comprising a processor, wherein the processor is configured to receive a plurality of inputs from a user including character features and an idol's assigned color, create, based on the plurality of inputs, a prompt for instructing a generative AI model to generate an abstract image or a monogram, and input the prompt to the generative AI model to cause the generative AI model to generate the abstract image or the monogram. The processor is further configured to apply an emotion analysis algorithm to analyze an emotion of the user and adjust a color tone of the abstract image or the monogram to be generated, based on a result of the analysis, thereby enabling generation of images or monograms that more closely reflect the user's emotional state. In addition, the processor is configured to present specific procedures to the user to provide instructions for creating fan items based on the generated abstract image or the generated monogram, and to output the generated abstract image or the generated monogram as pixel art and provide the pixel art in a format usable as an icon for a social networking service. Through these features, the system enables emotionally adaptive generation of abstract images or monograms, practical support for creating physical fan goods, and convenient utilization of the generated designs in digital environments.

The term “processor” refers to one or more hardware processing units, such as a central processing unit (CPU), graphics processing unit (GPU), digital signal processor (DSP), or any combination thereof, capable of executing instructions to perform the functions described in the present specification and claims.

The term “user” refers to a human operator who provides inputs, such as character features and an idol's assigned color, and who receives and utilizes the abstract image, monogram, fan item instructions, or pixel art generated by the system.

The term “character features” refers to attributes, traits, motifs, or descriptive keywords associated with a fictional or real character, including, for example, physical characteristics, accessories, personality traits, or thematic elements, which are used as input to influence the generated abstract image or monogram.

The term “idol's assigned color” refers to a specific color, typically predetermined and uniquely associated with an idol, performer, or character, which is used as a theme or accent color in generating the abstract image, monogram, or pixel art.

The term “generative AI model” refers to a machine learning model, such as a neural network-based image generation model, configured to create new content, including abstract images or monograms, in response to an input prompt that specifies conditions or constraints.

The term “prompt” refers to a set of instructions, textual data, parameters, or structured input generated by the processor based on the user's inputs, which is provided to the generative AI model to control or guide the generation of an abstract image or monogram.

The term “abstract image” refers to a non-photorealistic or stylized graphical representation that may include shapes, colors, patterns, or simplified motifs, and that is generated based on the user's inputs and the prompt, without necessarily depicting a realistic object or scene.

The term “monogram” refers to a graphical design that combines one or more letters, symbols, or initials, optionally along with shapes or decorative elements, to represent a character, idol, or concept derived from the user's inputs.

The term “emotion analysis algorithm” refers to a software-implemented procedure or model configured to analyze data related to the user, such as textual input, behavioral information, or other signals, to estimate or infer an emotional state of the user.

The term “emotion of the user” refers to an emotional state or affective condition of the user, such as happiness, excitement, calmness, or sadness, as inferred or classified by the emotion analysis algorithm.

The term “color tone” refers to one or more parameters defining the appearance of a color in the generated abstract image or monogram, including but not limited to hue, saturation, brightness, lightness, contrast, or combinations thereof.

The term “fan items” refers to physical or digital goods created by or for the user to express support for or attachment to a character or idol, including, for example, accessories, decorations, art pieces, or other “oshi” goods derived from the generated abstract image or monogram.

The term “specific procedures” refers to step-by-step instructions, sequences of actions, or detailed guidance presented to the user for creating fan items based on the generated abstract image or monogram.

The term “pixel art” refers to a digital image composed of discrete pixels arranged in a grid, typically at a relatively low resolution, where each pixel is intentionally placed or colored to form a stylized representation of the abstract image or monogram.

The term “social networking service” refers to an online platform or application that enables users to create profiles, share content, and interact with other users, and includes, for example, social media services, community sites, and messaging platforms that allow the use of icons or avatars.

The term “format usable as an icon for a social networking service” refers to a digital image file format and size suitable for use as an avatar or icon in a social networking service, such as a square or circular image encoded in a standard image format (for example, PNG or JPEG) and having a resolution appropriate for display in user profiles or message interfaces.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

First Exemplary Embodiment

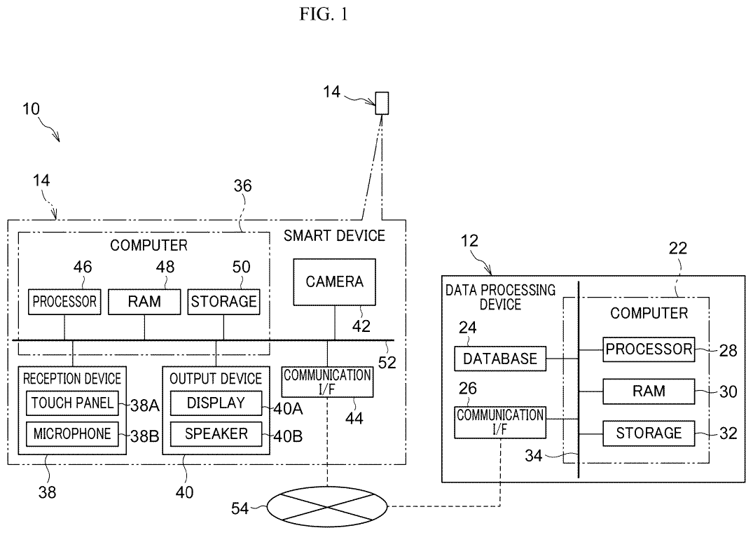

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

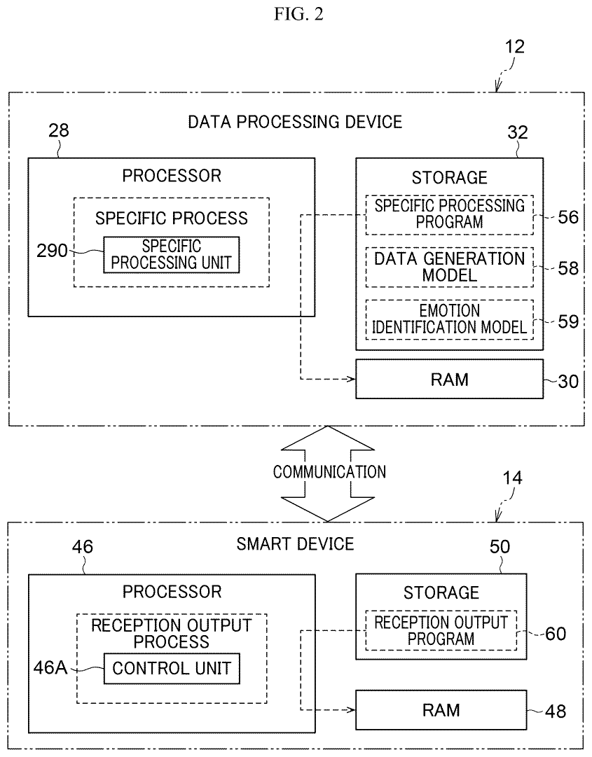

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content generation systems that utilize generative artificial intelligence models typically accept free-form user input and directly submit such input as a prompt sentence to the model. In these systems, processing logic on the server side is often limited to relaying user text to the model and returning the generated result to a client device. As a result, several technical problems arise in the context of computer technology.

First, because user input is not systematically structured, conventional servers do not efficiently exploit attribute information and color information included in the input. The lack of structured representation leads to prompt sentences that are ambiguous or incomplete, causing unstable generation results and forcing repeated interactions between the user terminal and the server. This results in unnecessary network traffic, increased server load, and degradation of throughput of the overall system.

Second, conventional systems do not integrate natural language processing and emotion analysis into the prompt construction pipeline in a coordinated manner. Emotional aspects of user intent are not reflected in the generation process in a controlled, machine-tractable form. Consequently, servers cannot dynamically adjust low-level parameters, such as color tone or compositional elements of generated visual information, based on user emotion. This restricts the server's ability to adapt content generation to the user's emotional context, and prevents efficient reuse of computationally expensive generative model outputs.

Third, generated content is often returned to the client as large images or lengthy text without any standardized transformation for subsequent usage. For example, there is no built-in mechanism in the server to reconstruct visual information as low-resolution graphic information suitable as an identification image in communication networks, or to compute presentation instruction information, such as layout methods or production procedures of decorative articles. This imposes additional processing burdens on client devices and external services, which must perform their own transformations using separate computation, thereby increasing latency and consuming additional processing resources across the distributed system.

Fourth, the absence of an integrated pipeline-from structured input analysis, emotion-aware prompt sentence generation, generative model invocation, through to postprocessing into standardized formats-prevents effective optimization of memory usage and computational scheduling on the server. Each functional step is often implemented as a separate, loosely coupled component, causing redundant conversions between data formats and preventing global optimizations, such as caching of intermediate structured information or reuse of generation description information across multiple content generation requests.

Accordingly, there is a need for an improved server-side computer-implemented system that: (i) converts user attribute information and color information into structured information suitable for computation; (ii) uses natural language processing to generate refined generation description information and a corresponding prompt sentence for a generative artificial intelligence model; (iii) performs emotion analysis and dynamically adjusts content data at the server level; and (iv) generates standardized content formats and presentation instruction information to reduce processing burdens on client devices and improve the efficiency, determinism, and scalability of computer-based content generation.

The specific processing by the specific processing unit 290 of the data processing device 12 in Example 1 is realized by the following means.

The present invention provides a server comprising a processor configured to receive, from a user, a plurality of information inputs including attribute information and color information and convert the attribute information and the color information into structured information, apply a natural language processing algorithm to the structured information to perform segmentation into linguistic units and extraction of important linguistic units, generate generation description information based on a result of the extraction, create a prompt sentence by using the generation description information and the color information, embed the generation description information into the prompt sentence, input the prompt sentence to a generative artificial intelligence model to cause the generative artificial intelligence model to generate content data comprising visual information or character information, apply an emotion analysis algorithm to at least one of the attribute information and the content data to analyze an emotional state of the user, dynamically adjust at least one of a color tone and a component of the content data based on a result of the analysis and the color information, transmit the adjusted content data to a user information processing terminal, convert the adjusted content data into a format displayable or outputtable by the user information processing terminal, generate presentation instruction information including at least one of a layout method and a production procedure of a decorative article based on the adjusted content data and the structured information, and, when the content data comprises visual information, reconstruct the visual information as a sequence of pixel information to output the visual information as low-resolution graphic information usable as an identification image on a communication network. This enables improved computer operation by providing an integrated server-side pipeline that structurally analyzes user input, constructs emotion-aware prompt sentences for a generative AI model, standardizes and postprocesses generated content into optimized formats, and thereby reduces redundant computation, network bandwidth usage, and client-side processing load while increasing determinism, responsiveness, and scalability in content generation systems.

The term “user” refers to a human individual or an organization that provides information inputs to the system and receives content data through a user information processing terminal.

The term “processor” refers to a hardware processing unit or a combination of hardware processing units, such as a central processing unit or a graphics processing unit, configured to execute program instructions for implementing the functions of the system.

The term “information input” refers to digital data provided by the user, including at least attribute information and color information, and transmitted from the user information processing terminal to the server.

The term “attribute information” refers to descriptive information indicating characteristics, features, or properties of an object, character, or concept specified by the user.

The term “color information” refers to information specifying one or more colors or color schemes, including but not limited to main colors, accent colors, or color tones designated by the user.

The term “structured information” refers to information that has been converted from raw user input into a machine-readable and organized format, such as key-value pairs, lists, or other data structures, suitable for subsequent computational processing.

The term “natural language processing algorithm” refers to a software-implemented procedure configured to analyze and transform natural language text, including at least segmentation into linguistic units and extraction of important linguistic units.

The term “linguistic unit” refers to a basic element of natural language text obtained by segmentation, including, for example, words, phrases, or tokens.

The term “important linguistic unit” refers to a linguistic unit that is determined by the natural language processing algorithm to be semantically significant for representing the user's intent or for constructing a prompt sentence.

The term “generation description information” refers to descriptive information derived from the important linguistic units and structured information, which summarizes or represents content to be generated by a generative artificial intelligence model.

The term “prompt sentence” refers to a natural language text string that includes the generation description information and optionally color information, and that is provided as input to a generative artificial intelligence model to instruct the model to generate content data.

The term “generative artificial intelligence model” refers to a computational model trained using machine learning techniques and configured to generate new content data, such as visual information or character information, in response to a prompt sentence.

The term “content data” refers to data generated by the generative artificial intelligence model, including at least visual information or character information, and optionally metadata associated with the generated data.

The term “visual information” refers to image data or graphical data that can be displayed on a display device, including but not limited to illustrations, icons, or other graphical representations.

The term “character information” refers to text data generated by the generative artificial intelligence model, including but not limited to narratives, descriptions, or other sequences of characters in a natural language.

The term “emotion analysis algorithm” refers to a software-implemented procedure configured to estimate or classify an emotional state of the user by analyzing at least one of attribute information and content data.

The term “emotional state” refers to an inferred or estimated condition representing a user's emotion, such as happiness, sadness, excitement, or calmness, as determined by the emotion analysis algorithm.

The term “color tone” refers to a property of color appearance in visual information, including at least hue, saturation, and brightness, that can be adjusted by the processor.

The term “component of the content data” refers to a constituent element of the content data, including, for visual information, elements such as objects, backgrounds, or shapes, and, for character information, elements such as sentences, phrases, or stylistic attributes.

The term “user information processing terminal” refers to an electronic device operated by the user, such as a portable terminal, a stationary terminal, or another computing device, configured to transmit information inputs to the server and display or output the adjusted content data.

The term “format displayable or outputtable by the user information processing terminal” refers to a data format that can be directly presented or rendered by hardware and software of the user information processing terminal, such as an image file format or a text encoding format.

The term “presentation instruction information” refers to information generated by the processor that specifies at least one of a layout method or a production procedure of a decorative article based on the adjusted content data and the structured information.

The term “layout method” refers to instructions for spatial arrangement, positioning, or composition of elements of the content data when the content data is displayed or physically arranged.

The term “production procedure of a decorative article” refers to a sequence of steps or instructions for creating a physical or digital decorative item using the content data.

The term “sequence of pixel information” refers to an ordered set of data elements, each representing color or intensity values of a pixel in the visual information.

The term “low-resolution graphic information” refers to visual information represented with a reduced number of pixels or lower spatial resolution compared to the original visual information, suitable for compact display or transmission.

The term “identification image” refers to a visual representation used to identify a user, object, or entity on a communication network, such as an icon or a profile image.

The term “communication network” refers to an infrastructure configured to transmit and receive digital data between devices, including at least wired or wireless networks.

In one embodiment, a server cooperates with a terminal operated by a user to implement a content generation system based on a generative AI model. The server includes at least one processor, a main memory, a non-volatile storage device, a network interface, and, in certain embodiments, a graphics processing unit (GPU). The terminal includes a processor, a memory, a display device, an input device, and a network interface. The server executes software components including a web server, an application server, a natural language processing (NLP) module, an emotion analysis module, a generative AI inference module, an image processing module, and a data storage module.

The server executes a web server program, which can be implemented by general-purpose web server software such as an HTTP server. The web server receives Hypertext Transfer Protocol Secure (HTTPS) requests from the terminal via a communication network and forwards the requests to the application server. The application server is implemented by an execution environment such as a script execution runtime or a web application framework. The application server executes program instructions that control the overall flow of receiving user input, performing structured data processing, generating a prompt sentence, invoking the generative AI model, performing emotion-based adjustment, and returning processed content data to the terminal.

The terminal executes a web browser or a dedicated application program to display a graphical user interface. The terminal presents input fields for attribute information and color information, and transmits user-specified data to the server via the network interface. The terminal then receives content data from the server, including generated images or text, and renders the content data on the display device. The terminal can be implemented by a smartphone, a tablet device, a desktop computer, or any other general-purpose information processing device.

The server converts user-provided attribute information and color information into structured information. The server stores the raw user input as text strings, and then processes the text using NLP libraries such as a tokenizer and a part-of-speech tagger. The server constructs internal data structures, for example, key-value mappings and lists representing physical traits, personality traits, and color scheme parameters. The server stores such structured information in main memory and, optionally, in a database management system such as a relational database or a document database.

The server applies a natural language processing algorithm to the structured information to derive generation description information. The NLP algorithm uses, for example, tokenization, lemmatization, phrase chunking, and importance scoring to identify important linguistic units. The server assigns importance scores based on frequency, part-of-speech patterns, and user-specified emphasis markers. Weighted combinations of the identified phrases are then used to construct generation description information that more precisely captures user intention than the raw input.

The server creates a prompt sentence from the generation description information and the color information. The server uses prompt templates stored in a configuration storage area. These templates can include variables for character attributes, colors, style, and usage context. The server fills the templates with the generation description information and color data to generate a final prompt sentence. For example, the server creates prompt sentences such as:
“Please generate an illustration of a cheerful character with cat ears and long hair, wearing mainly pink with white accents.”
“Please generate an illustration of a character with cat ears wearing a pink outfit.”
“Please write a short story about a kind blue robot with silver accents, in a warm and emotional tone.”
“Please generate an illustration of a magician character whose main color theme is purple and gold.”

The server embeds the generation description information in the prompt sentence in a non-trivial way. In one embodiment, the server imposes a specific order of clauses to align with known sensitivities of the generative AI model's attention mechanism. The server also injects structural tokens or delimiters that are designed to guide the model's encoder to emphasize certain features. Such deliberate structuring of the prompt sentence leads to more stable and reproducible outputs, thereby improving the determinism and efficiency of the generative process.

The server invokes a generative AI model using the prompt sentence as input. The generative AI model is implemented as a neural network model stored in a model repository and executed by an inference engine. In one embodiment, the generative AI model is a transformer-based language model for generating character information and a diffusion-based model for generating visual information. The transformer model includes an embedding layer, multiple self-attention layers, feedforward layers, and a final classification layer that outputs a probability distribution over next tokens. The diffusion model includes a denoising network implemented by a U-Net architecture, operating over a latent representation of an image. Model parameters are stored in main memory or GPU memory during inference.

The server performs inference on the generative AI model using a specific set of parameters. For the text-generating model, the server uses a temperature parameter, a top-k or top-p sampling method, and a maximum token count. For the image-generating model, the server uses a number of denoising steps, a guidance scale factor, and a latent resolution. These parameters are determined by configuration data and may be adapted based on system load or user profile settings. The server therefore controls internal numerical operations of the generative AI model, such as matrix multiplications, attention weight computations, and iterative denoising processes executed on the GPU.

The server executes an emotion analysis algorithm to estimate an emotional state of the user. The server uses either the attribute information or the generated content, or both, as input to an emotion classification model. In one embodiment, the emotion analysis model is a supervised-learning classifier implemented as a neural network or a support vector machine. The server extracts features such as sentiment scores, emotional keywords, and color associations, and maps them to an emotion label or a continuous emotional intensity vector. The server stores the emotional state as a vector including dimensions such as joy, sadness, excitement, and calmness.

The server uses the emotional state to adjust the content data. For visual information, the server modifies color tone parameters. The server converts the image into a color space such as HSV or Lab and adjusts hue, saturation, and brightness in predetermined ranges depending on the emotional state. For example, in a “calm” state, the server reduces saturation and selects softer hues; in an “excited” state, the server increases saturation and brightness. This adjustment is carried out by an image processing module using image manipulation libraries and GPU-accelerated operations, thereby enabling efficient batch processing of large images.

For character information, the server modifies stylistic features such as sentence length, word choice, and level of detail. The server can perform a second-stage generation or post-editing step using the generative AI model, or a dedicated rewriting model, guided by the emotional state vector. The server adjusts temperature and penalty parameters in the language model to shift the tone while maintaining the core semantics defined by the generation description information. These adjustments result in content that more accurately reflects the user's emotional context without requiring the user to explicitly specify complicated instructions.

The server generates presentation instruction information based on the adjusted content data and the structured information. The server uses rule-based logic and heuristic algorithms to derive layout methods and production procedures of decorative articles. For example, when the content data is an image of a character, the server computes a bounding box around the main subject, arranges it in a template for goods design, and calculates margins and scaling factors. When the content data is text, the server determines font size, line spacing, and text placement relative to visual elements. The server represents these instructions as a structured description that can be interpreted by printing software or manufacturing equipment.

The server reconstructs visual information as low-resolution graphic information for use as identification images in communication networks. The server downsamples the generated image using resampling algorithms such as bilinear or bicubic interpolation. The server then quantizes color values to a limited palette suitable for low-resolution icons or pixel art. The server encodes the result in a compact image format. This transformation reduces storage usage and network bandwidth when the image is used as a user icon or profile image on multiple services.

The server manages data structures in a manner that improves computational efficiency. The server maintains separate memory regions for raw user input, structured information, generation description information, prompt sentences, intermediate model outputs, and final content data. The server uses identifiers to associate these data records across modules, which allows caching and partial reuse of intermediate results. For instance, when a user changes only the emotional context while maintaining the same attribute information, the server reuses the previously generated content data and applies only the color tone adjustment, avoiding re-execution of the generative AI model. This selective reuse reduces computation time and GPU utilization.

The server uses specific learning and update methods for the generative AI model and the emotion analysis algorithm. In one embodiment, the generative AI model is pretrained on large-scale datasets using stochastic gradient descent or a variant such as Adam. The server defines a loss function combining reconstruction loss, perceptual loss, and regularization terms. For the emotion analysis algorithm, the server trains a classifier on labeled text and image data using cross-entropy loss, and updates model weights using backpropagation. Data augmentation is used during training, including random cropping, color jittering for images, and synonym replacement for text. These design choices improve generalization performance, which directly enhances the accuracy and consistency of inference operations on the deployed server.

The server thereby improves computer technology by introducing a non-conventional, integrated pipeline that tightly couples structured NLP preprocessing, emotion-aware prompt sentence construction, controlled generative AI inference, and standardized postprocessing. In contrast to merely automating human design work, the server optimizes data structures, parameter configurations, and inter-module communication to reduce unnecessary data transfer, minimize redundant computations, and enhance determinism of model outputs. For example, by separating generation description information from emotional adjustment parameters, the server can cache and reuse semantically stable descriptors across multiple generations, while only recalculating lightweight color or style adjustments. This design reduces average response time and resource consumption.

The terminal benefits from reduced processing load because the server performs the majority of heavy computation and data transformation. The terminal processes only display-ready content and simple control commands, which enables the system to operate on low-powered devices. The reduction in required bandwidth due to low-resolution image variants and structured presentation instructions further allows the terminal to operate effectively on constrained networks.

The user interacts with the system through intuitive operations on the terminal. The user enters natural language descriptions and color selections rather than low-level design commands. However, the server transforms these high-level inputs into highly structured and optimized internal representations, which are specifically adapted to the characteristics of the generative AI model and to the capabilities of the image processing and text processing subsystems. This transformation is not a mere automation of human decision making; rather, it exploits internal properties of neural network architectures and inference algorithms to achieve results that are not practically attainable by manual operation alone.

In alternative embodiments, the server employs different types of generative AI models, such as a generative adversarial network for image generation or a variational autoencoder for style transfer. The server may also use different network architectures for emotion analysis, including recurrent neural networks, convolutional neural networks applied to text embeddings, or hybrid architectures. The server can further adjust its algorithms to support additional modalities, such as audio or video, by extending the structured information and generation description information to include modality-specific features.

In another variation, the server operates in a distributed environment with multiple processing nodes. The server assigns NLP preprocessing and emotion analysis tasks to central processing units, while assigning generative inference and image postprocessing to GPUs on dedicated nodes. The server uses a task scheduler to allocate jobs based on current load conditions. This architecture enables horizontal scaling and further reduces latency by parallelizing independent operations.

In all of these embodiments, the server, the terminal, and the user interact within a system that improves core aspects of computer-based content generation. The technical effects include faster response times due to reuse of structured information, improved accuracy and relevance of generated content due to emotion-aware prompt construction, reduced communication load due to low-resolution graphic generation and standardized formats, and more efficient use of computational resources due to deliberate separation of heavy and light processing stages.

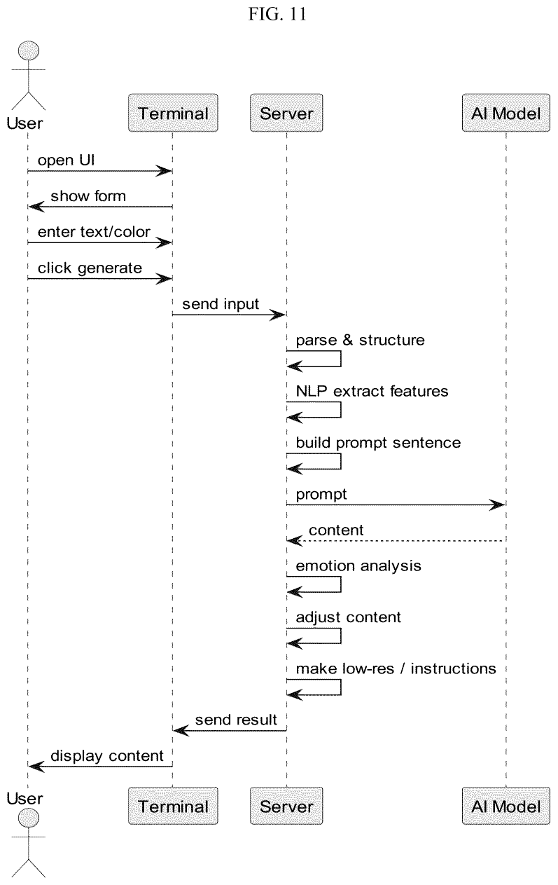

The following describes the processing flow using FIG. 11.

### Step 1

The user operates the terminal to launch a browser or application and open a user interface screen. The terminal displays at least one text input field for attribute information and at least one color selection control for color information. The input to this step is an initial empty user interface, and the output is a populated interface that can accept user text and color selections, rendered on the terminal display using the terminal's processor and graphics subsystem.

### Step 2

The user inputs attribute information and color information through the terminal. The user types natural language text describing character or item features, and selects one or more colors using a color picker or palette widget. The input to this step is the visual interface elements rendered on the terminal; the output is raw user input data held in the terminal's memory as text strings and color values, such as RGB codes or color names.

### Step 3

The terminal packages the raw user input into a structured message and transmits it to the server. The terminal converts the attribute text and color selections into a data structure, for example key-value pairs representing “features” and “colors,” and serializes this structure into a request body. The input to this step is the raw attribute text and color values stored locally; the output is a network message sent via a communication protocol to the server, containing the user's attribute information and color information in a machine-readable format.

### Step 4

The server receives the network message from the terminal through a network interface and parses the request. The server's web server component reads the message, verifies its integrity, and passes the payload to an application server. The input to this step is the serialized request received over the network; the output is an internal representation of the user's attribute information and color information, stored as in-memory data structures such as strings and associative arrays.

### Step 5

The server converts the raw attribute information and color information into structured information. The server splits the input text into fields, normalizes character encoding, and associates each field with a semantic role, for example physical traits, personality traits, or usage context. The server combines these fields with color information into a unified structured record. The input to this step is the parsed raw text and color values, and the output is structured information where each element is explicitly labeled and ready for further computational processing.

### Step 6

The server applies a natural language processing algorithm to the attribute information within the structured information. The server tokenizes the text into linguistic units, performs part-of-speech tagging, and groups tokens into phrases. The server calculates importance scores for each phrase using frequency measures, syntactic patterns, or predefined rules. The input to this step is the attribute portion of the structured information; the output is a set of important linguistic units and associated scores that represent key features extracted from the user's description.

### Step 7

The server generates generation description information based on the important linguistic units and the structured information. The server aggregates selected phrases, removes redundancies, and orders them according to predefined rules that align with generative model behavior. The server may also incorporate color-related descriptors into the description. The input to this step is the set of important linguistic units and the color-related parts of the structured information; the output is generation description information expressed as one or more concise descriptive phrases capturing what should be generated.

### Step 8

The server constructs a prompt sentence for a generative AI model using the generation description information and the color information. The server selects a template according to the requested content type, for example image or text, and fills placeholders with the generation description information and specific color terms. The server concatenates clauses, inserts delimiters or emphasis markers, and forms a complete prompt sentence. The input to this step is the generation description information and the color information; the output is a finalized prompt sentence in natural language, such as “Please generate an illustration of a cheerful character with cat ears and long hair, wearing mainly pink with white accents.”

### Step 9

The server determines which generative AI model to call and prepares model-specific parameters. The server consults configuration data or user settings to choose between a text-generating model and an image-generating model, and sets parameters such as maximum token length, temperature, guidance scale, or number of inference steps. The input to this step is the prompt sentence and the content type requirement; the output is a selected model identifier together with a parameter set defining how the model will process the prompt sentence.

### Step 10

The server invokes the generative AI model with the prompt sentence and parameters. The server transfers the prompt sentence and configuration to an inference engine running on a processor or GPU, which executes a neural network architecture such as a transformer or diffusion model. The internal processing includes matrix multiplications for attention, non-linear activations, and iterative sampling steps. The input to this step is the prompt sentence and the model configuration; the output is preliminary content data generated by the model, consisting of either visual information in an internal representation or character information as a sequence of tokens.

### Step 11

The server decodes the model's internal output into usable content data. For visual information, the server decodes latent tensors into pixel values and encodes them as an image file in a standard format. For character information, the server converts token IDs into text characters using a vocabulary mapping and assembles them into human-readable sentences. The input to this step is the model's internal representation of the generated result; the output is content data expressed as an image file or a text string that can be stored, displayed, or further processed.

### Step 12

The server applies an emotion analysis algorithm to at least one of the attribute information and the content data in order to estimate an emotional state of the user. The server extracts features, such as sentiment scores from the attribute text and color distribution statistics from the generated image, and feeds these features into a trained classifier or regression model. The input to this step is the structured attribute information and/or the generated content data; the output is an emotional state representation, for example a label or a vector indicating intensities of multiple emotions.

### Step 13

The server adjusts at least one of a color tone and a component of the content data based on the emotional state and the color information. For visual information, the server performs image processing operations such as shifting hue values, modifying saturation, and changing brightness in a color space to match the desired emotional tone. For character information, the server rewrites certain phrases or adjusts stylistic markers using a secondary text-processing routine. The input to this step is the emotional state, the original content data, and the original color information; the output is adjusted content data whose visual or textual properties have been modified according to emotion-aware rules.

### Step 14

The server generates presentation instruction information from the adjusted content data and the structured information. The server calculates layout positions, scaling factors, and recommended placements for visual elements, or generates step-by-step procedures for creating a decorative item using the content data. The input to this step is the adjusted content data and the structured information that includes user preferences and attributes; the output is presentation instruction information describing how the content should be arranged, displayed, or physically produced.

### Step 15

The server produces a low-resolution graphic variant when the content data includes visual information. The server downsamples the image by computing new pixel values from neighborhoods of original pixels, and optionally reduces the color palette. The input to this step is the adjusted visual content data in full resolution; the output is low-resolution graphic information suitable for use as an identification image on a communication network.

### Step 16

The server prepares a response package containing at least the adjusted content data and optionally the presentation instruction information and the low-resolution graphic information. The server organizes these elements into a response structure, encodes them in a transmission format, and adds identifiers or metadata such as content type and timestamps. The input to this step is the adjusted content data, the presentation instruction information, and the low-resolution graphic information; the output is a server response object ready to be sent to the terminal.

### Step 17

The server transmits the response package to the terminal via the communication network. The server uses its network interface to send the encoded response as one or more messages over a transport protocol. The input to this step is the encoded response object in the server's memory; the output is a stream of data packets delivered to the terminal, containing the generated and processed content.

### Step 18

The terminal receives the response from the server and parses the contained data. The terminal's network stack reassembles the packets, and an application component decodes the response into individual elements such as the main content data, any presentation instruction information, and any low-resolution image. The input to this step is the network data received from the server; the output is internal terminal data structures containing the server-generated content and associated instructions.

### Step 19

The terminal renders the received content for the user. For visual information, the terminal loads the image into an image display component and draws it on the screen using the graphics subsystem. For character information, the terminal displays the text in a text area component with appropriate formatting. If presentation instruction information is present, the terminal arranges multiple elements on the screen according to the specified layout or presents step-by-step guidance. The input to this step is the parsed content data and instructions; the output is a visual or textual presentation of the generated content on the terminal display.

### Step 20

The user views and optionally interacts with the generated content displayed on the terminal. The user may inspect the adjusted image or story, follow the presentation instructions, adopt the low-resolution graphic as an identification image, or request further modifications by providing new input. The input to this step is the displayed content and any optional controls provided by the terminal; the output is either user satisfaction with the current content or additional user commands that may trigger another cycle of processing in the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize generative AI models typically require users to manually craft detailed prompt sentences in natural language. In many cases, users lack the expertise to translate intuitive, domain-specific preferences, such as character appearance, personality, and color scheme, into effective prompts. As a result, the generated visual content often fails to match the user's intent, and repeated trial-and-error input degrades usability and system efficiency.

Furthermore, known systems generally treat generative AI models as black boxes that accept raw text, without performing structured preprocessing of user input or systematic post-processing of generated content. Such systems lack mechanisms for normalizing user inputs, standardizing color information, or enforcing consistent style conditions. This leads to non-deterministic and inconsistent outputs, making it difficult to provide predictable quality and to integrate the generated content into downstream workflows, such as preparing items for display, decoration, or social-network usage.

In addition, conventional systems do not effectively leverage emotion analysis to adapt generation instructions. Even where emotion analysis algorithms are available, they are rarely integrated in a feedback loop that dynamically adjusts prompt descriptions, including color tone and style, based on the user's emotional state and reactions to previously generated content. As a consequence, existing solutions are limited in their ability to personalize visual content in a way that reflects evolving user sentiment and enhances engagement.

From a computer-technology perspective, existing architectures do not provide an integrated pipeline that: (i) converts heterogeneous user inputs from terminals into normalized, structured data; (ii) synthesizes that data into a machine-generated prompt sentence tailored to a generative AI model; (iii) post-processes the generative AI output into device-appropriate formats; and (iv) persists and associates prompt history, user inputs, and emotion analysis results in a systematic manner. This lack of end-to-end orchestration results in redundant processing, inconsistent data representations, inefficient use of network and storage resources, and difficulty in reusing or managing generated content.

Accordingly, there is a need for a computer-implemented system that improves the way computing resources handle user input, prompt construction, model invocation, and content post-processing. Such a system should automatically transform intuitive user inputs into structured representations, generate optimized prompt sentences for a generative AI model, adjust generation parameters based on emotion analysis, and efficiently deliver and manage visual content data across terminals and communication networks. By improving these fundamental data flows and control mechanisms, the system can enhance both the technical performance and the consistency of AI-based content generation and distribution.

The specific processing by the specific processing unit 290 of the data processing device 12 in Application Example 1 is realized by the following means.

The present invention provides a server comprising a processor, a memory, and a communication interface, the processor being configured to receive, from a terminal operated by a user, a plurality of input information items including attributes related to an appearance and a personality of a character and attributes related to a color scheme, to acquire the plurality of input information items as structured data, to perform normalization processing and attribute completion processing on the structured data including converting the attributes related to the color scheme into standardized color classification information and integrating the attributes related to the appearance and the personality of the character into descriptive information, to generate, based on the descriptive information and the color classification information, a natural-language prompt sentence in accordance with predetermined sentence-structure rules and style conditions and to input the prompt sentence to a generative AI model, to obtain visual content data output from the generative AI model, to perform post-processing on the visual content data including adjusting at least one of a pixel count, an encoding scheme, and a storage format of the visual content data, to transmit the post-processed visual content data to the terminal via the communication interface, to control the terminal to display the visual content data and to store the visual content data in association with the prompt sentence and the plurality of input information items as history information, to present, on the terminal, operation procedures for sharing the visual content data with another user, and to apply an emotion analysis algorithm to emotion-related input information from the user and to the visual content data and to dynamically adjust, based on an analysis result, at least a description related to a color tone and a description related to a style contained in the prompt sentence. This enables an improved computer-implemented pipeline that automatically converts heterogeneous user inputs into normalized structured data, synthesizes optimized prompt sentences for a generative AI model, adaptively refines generation instructions based on emotion analysis, and efficiently delivers and manages visual content in device-appropriate formats, thereby enhancing consistency, personalization, and resource usage in AI-based content generation and distribution.

The term “system” refers to a combination of at least one processor, a memory, a communication interface, and one or more terminals, configured to cooperate to execute the functionalities described in the claims.

The term “processor” refers to one or more hardware processing units, such as a central processing unit or a graphics processing unit, capable of executing program instructions to perform logical operations, numerical operations, and control operations described in the claims.

The term “memory” refers to one or more computer-readable storage media, such as semiconductor memory, magnetic storage, or optical storage, configured to store program instructions, configuration data, intermediate data, and output data used or generated by the processor.

The term “communication interface” refers to a hardware and software subsystem that enables data exchange between the processor and external devices or networks, including wired and wireless interfaces implementing communication protocols.

The term “terminal” refers to an information processing device operated by a user, such as a smartphone, tablet, personal computer, or similar device, which is configured to send input information to the server and receive and display visual content data.

The term “user” refers to a human operator who interacts with the terminal, provides input information such as character attributes and emotional information, and views or shares visual content data.

The term “input information” refers to data representing user-specified parameters, including but not limited to character-related attributes, color-related attributes, style preferences, and emotion-related information, which are provided from the terminal to the server.

The term “structured data” refers to data that is organized according to a predefined schema, such as key-value pairs or records, enabling systematic processing, validation, and transformation by the processor.

The term “normalization processing” refers to processing that converts heterogeneous or inconsistent input values into standardized representations, such as unifying synonymous terms, trimming extraneous characters, and aligning formats for subsequent use.

The term “attribute completion processing” refers to processing that infers or supplements missing or implicit attribute values based on predefined rules, default settings, or mappings, thereby enriching the structured data for generation.

The term “attributes related to an appearance and a personality of a character” refers to descriptive elements that specify visual or behavioral aspects of a fictional or representative entity, such as accessories, hairstyle, demeanor, or role.

The term “attributes related to a color scheme” refers to descriptive elements that specify one or more colors or color combinations to be applied to the visual representation, such as main color, accent color, or thematic palette.

The term “standardized color classification information” refers to color-related data expressed according to a predetermined classification system, such as normalized color names, codes, or categories, that enable consistent interpretation and use by the processor and the generative AI model.

The term “descriptive information” refers to natural-language or symbolic text that integrates multiple attributes, including character-related and color-related attributes, into a coherent description suitable for inclusion in a prompt sentence.

The term “prompt sentence” refers to a natural-language instruction generated by the processor, which encodes descriptive information, color classification information, and style conditions, and is provided as input to the generative AI model to guide content generation.

The term “generative AI model” refers to a machine-learned model, such as a neural network-based generative model, configured to generate visual content data in response to a prompt sentence and associated parameters.

The term “visual content data” refers to digital data representing visual media, such as images, graphics, or frames of animation, which is generated by the generative AI model and can be displayed on a display device.

The term “post-processing” refers to processing performed on visual content data output from the generative AI model, including, but not limited to, adjusting resolution, modifying encoding format, compressing data, cropping, or otherwise transforming the data for optimized storage or display.

The term “pixel count” refers to the number of pixels constituting the visual content data, including dimensions such as width and height, which determine the resolution of the displayed content.

The term “encoding scheme” refers to a method or format used to represent visual content data for storage or transmission, such as a particular image codec or file format.

The term “storage format” refers to a data representation, including file type, container structure, and metadata arrangement, used when storing the visual content data in memory or external storage.

The term “display device” refers to a hardware component of the terminal, such as a liquid crystal display or an organic light-emitting diode panel, capable of presenting visual content data to the user.

The term “history information” refers to data records that associate past visual content data with corresponding prompt sentences, input information, timestamps, and other metadata, enabling later retrieval, display, or analysis.

The term “operation procedures for sharing” refers to instructions, user interface elements, or workflows presented on the terminal that guide the user in transmitting visual content data or associated identifiers to other users or external services.

The term “emotion analysis algorithm” refers to a computational procedure or model that processes emotion-related input information and/or reaction data to infer one or more emotional states or tendencies of the user.

The term “emotion-related input information” refers to data indicative of a user's emotional state, such as self-reported emotions, reaction selections, or interaction patterns, that is provided to or derived by the system.

The term “analysis result” refers to output data produced by the emotion analysis algorithm, representing inferred emotional categories, scores, or tendencies, which can be used to modify generation parameters.

The term “description related to a color tone” refers to a portion of the prompt sentence or descriptive information that specifies qualitative or quantitative aspects of color, such as brightness, saturation, warmth, or dominance of particular colors.

The term “description related to a style” refers to a portion of the prompt sentence or descriptive information that specifies artistic or visual style characteristics, such as a particular illustration style, realism level, viewpoint, or composition preference.

The term “work procedures” refers to a sequence of steps, instructions, or guidelines for producing a physical or digital item using visual content data, such as a decorative object, printed material, or display medium.

The term “decorative article” refers to a physical or digital item intended primarily for aesthetic or ornamental use, created at least in part from the visual content data provided by the system.

The term “display article” refers to a physical or digital item intended to visually present information or imagery, created at least in part from the visual content data, such as a poster, banner, or screen layout.

The term “pixel-level array data” refers to data that represents visual content as an ordered collection of pixel values, typically arranged in a two-dimensional or multi-dimensional array.

The term “simplified graphic data” refers to graphic data that has been reduced or abstracted from high-resolution visual content, such as a simplified icon-like representation or low-resolution image, while retaining identifiable features.

The term “short text information” refers to brief textual content, such as labels, identifiers, or short phrases, that can be combined with graphical elements to form identification display data.

The term “identification display data” refers to combined graphic and textual data intended to visually identify a user, account, resource, or content item in a user interface or network service.

The term “communication network service” refers to an information service provided over a communication network, such as a social platform, messaging service, or other online system, in which identification images or icons may be used.

The term “identification image” refers to an image used to visually represent an entity, such as a user profile, account, or channel, within a communication network service.

In one embodiment, a server cooperates with a terminal operated by a user to implement the claimed system. The server includes at least one central processing unit (CPU), at least one graphics processing unit (GPU), a main memory implemented as dynamic random-access memory (DRAM), a non-volatile storage device such as a solid-state drive (SSD), and a communication interface supporting wired and/or wireless communication protocols. The terminal includes a CPU, a memory, a display device, an input device such as a touchscreen, and a communication module. The server executes application software, such as a web application or an application programming interface (API) service, implemented, for example, using a server-side framework. The terminal executes a client application, such as a web browser or a native application, implemented, for example, using a graphical user interface toolkit or a browser engine.

The terminal presents to the user an input screen that includes text fields, selection controls, and buttons. The terminal allows the user to enter character-related attributes, including appearance attributes and personality attributes, and color-related attributes that indicate a desired color scheme. The terminal converts the user's operations into structured input information, for example an internal object containing fields such as character_appearance, character_personality, and color_scheme. The terminal stores this structured input information in a memory buffer and transmits it to the server over a communication network using a request message formatted according to a network protocol.

The server receives the request message through the communication interface and stores the message data in a receive buffer. The server decodes the message, for example by parsing a structured text format, and converts the decoded input information into an internal data structure managed in main memory. The server performs normalization processing on the input information. For appearance and personality attributes, the server applies rule-based transformations that map synonymous or variant expressions into canonical labels. For example, the server maps both “cat ears” and “nekomimi” to a canonical attribute “cat_ears”, and maps both “idol” and “performer” to a canonical attribute “idol_character”. The server stores mapping tables for these transformations in non-volatile storage and loads them into memory as lookup tables when the application is initialized.

The server performs attribute completion processing by referencing configuration data that define default attributes and correlation rules. For instance, when the user specifies only “cool idol” and “blue”, the server determines that a default attribute “short_hair” can be added based on a correlation rule stored in a rule set. The server represents such rules as conditional entries, where combinations of given attributes are associated with inferred additional attributes. The server evaluates these rules using deterministic logic evaluation in the CPU, which results in enrichment of the structured data before prompt construction.

The server converts color-related attributes into standardized color classification information. The server maintains a color dictionary that associates user-friendly terms, such as “light pink” or “hot pink”, with standardized color names and numeric codes such as values in a color space. The server accesses the color dictionary from memory and performs table lookup operations to map the user's color input to a canonical color label and associated parameters, for example a triplet of numeric values. The server thus ensures that all color-related attributes are represented by consistent numeric and symbolic values, which improves downstream processing and model conditioning.

The server integrates the normalized character attributes and standardized color classification information into descriptive information suitable for prompt generation. In one embodiment, the server constructs a description string by concatenating canonical attribute tokens with fixed connective phrases. For example, when the canonical attributes include “cat_ears”, “idol_character”, and “short_hair”, and the standardized color classification corresponds to “pink” as a main color, the server generates a descriptive phrase such as “a cute idol character with cat ears and short hair, using pink as the main color theme.” The server manages this construction using a template engine that applies sentence-structure rules defined in configuration data. These rules specify positions of attribute phrases, style phrases, and color phrases, as well as grammatical connectors. By enforcing these rules algorithmically, the server consistently produces well-formed natural-language descriptions.

The server then generates a prompt sentence for a generative AI model. The server combines the descriptive information with style conditions, such as “anime style”, “high resolution”, and “full body”, which are stored in a style configuration table. The server selects style conditions based on terminal type, user preferences, or system defaults. For example, when the terminal is a smartphone, the server can select a square aspect ratio and medium resolution, while when the terminal is a desktop system, the server can select a higher resolution and wider aspect ratio. The server embeds these style conditions into the prompt sentence according to the sentence-structure rules.

For example, the server generates a prompt sentence such as:
“Please generate a high-resolution anime-style illustration of a cute idol character with cat ears and short hair, using pink as the main color theme, standing in front of a simple background.”

In another example, when the user inputs attributes such as “cat ears” and “pink”, the server generates a prompt sentence such as:
“Please generate a high-resolution anime-style illustration of a cute character with cat ears, using pink as the main color theme.”

In a further example, when the user specifies “cool idol”, “blue”, and “short hair”, the server generates a prompt sentence such as:
“Generate a full-body anime illustration of a cool idol character with short hair, using blue as the main accent color, performing on a concert stage with dynamic lighting.”

The server supplies the prompt sentence to a generative AI model. In one embodiment, the generative AI model is a neural network model implementing a diffusion-based generative architecture. The server stores model parameters, including model weights and configuration, on a storage device and loads them into GPU memory for execution. The generative AI model includes a text encoder that converts the prompt sentence into a sequence of token embeddings using a transformer-based encoder, and a denoising network that iteratively refines a noise tensor into an image tensor conditioned on the encoded prompt. The denoising network uses a sequence of layers, including attention layers, convolutional layers, normalization layers, and nonlinear activation functions. The server configures parameters such as the number of diffusion steps, a guidance scale factor that balances fidelity to the prompt and image diversity, and a target spatial resolution.

The server invokes the generative AI model by providing the encoded prompt and model parameters. The GPU executes matrix multiplications and convolution operations to propagate activation values through the network, computing intermediate latent representations and finally an image tensor representing visual content. The server receives the generated image tensor, converts it to image data in a file format, and stores the resulting image data in memory or on disk.

The server performs post-processing on the visual content data. For example, the server adjusts the pixel count by scaling the image to a predetermined resolution appropriate for the terminal. The server applies an encoding scheme by converting the image to a compressed format and may include metadata such as color space information. The server selects a storage format, such as a file with a particular extension and structure, and assigns a unique identifier to the file. This post-processing is executed using image processing libraries that perform resampling, color conversion, and compression through numerical operations on pixel arrays.

The server transmits the post-processed visual content data to the terminal via the communication interface. In one embodiment, the server generates a network-accessible resource identifier for the image and includes it in a response message, together with metadata including the prompt sentence and the input information. The terminal receives the response message, extracts the resource identifier and other information, and then requests the image data if necessary. The terminal decodes the received image data and displays the visual content on the display device by instructing the graphics subsystem to render the pixel array. The terminal stores associations between the displayed image, the prompt sentence, and the original input information in local storage, enabling the user to review past generated content.

The terminal also presents operation procedures for sharing the visual content. For example, the terminal displays a “Share” button and, upon user operation, presents available sharing methods. The terminal can copy an identifier or open another application while passing the image identifier or a link. The server may also log sharing events in a database, but the primary function is that the system presents user interface elements that guide the user through device-level or application-level sharing workflows.

The server incorporates an emotion analysis algorithm to adapt the prompt sentence to the user's emotional state. In one embodiment, the server receives emotion-related input information from the terminal. This information can include explicit user selections such as “happy”, “calm”, or “excited”, or can be derived from user interactions such as repeated regeneration requests or dwell time on particular images. The server uses an emotion classifier implemented as a machine-learned model, such as a neural network with an input layer corresponding to features extracted from the emotion-related input information, one or more hidden layers, and an output layer representing emotion categories or continuous scores. The server computes feature vectors, for example by converting categorical selections into one-hot or embedding representations and by computing numeric features from usage patterns.

The server applies the emotion analysis algorithm to the feature vectors and obtains an analysis result consisting of emotion scores. The server uses the analysis result to adjust the prompt sentence. For color tone, the server maps certain emotional states to modified color parameters; for example, for a “calm” state, the server selects lower saturation and higher lightness, while for an “excited” state, the server selects higher saturation. The server modifies descriptive phrases in the prompt sentence, such as changing “using pink as the main color theme” to “using a soft pink as the main color theme” or “using a vivid pink as the main color theme” depending on the computed scores. For style, the server adjusts phrases like “anime style” to include additional descriptors such as “dynamic composition” or “minimalist composition” based on the emotion analysis. The server thus dynamically regenerates or updates the prompt sentence before submitting it to the generative AI model.

The server thereby improves computer technology in several ways. By normalizing and structuring user input at the server side, the system reduces ambiguity and variance in prompt content, which in turn increases the determinism and consistency of model outputs. This reduces the number of generation attempts necessary for a satisfactory result, thereby reducing processing load on the generative AI model and lowering network traffic between the server and the terminal. The use of canonical attributes and standardized color classification also allows the server to cache prompt encodings and reuse them across sessions when similar attributes are submitted, further improving computation efficiency.

The server's attribute completion processing and rule-based enrichment of the prompt sentence introduce a non-conventional data transformation step that is not merely a human-like rewriting of text. Instead, the server applies specific, machine-executable rules that combine structured attribute data and correlation rules to produce prompt sentences that a human user would not reliably produce without domain expertise. This machine-driven synthesis of prompts results in better utilization of the generative AI model's representational capacity, improving accuracy in matching user intent.

The server's integration of an emotion analysis algorithm with prompt adjustment forms a feedback loop that modifies low-level numeric representations of color and style before they are encoded for the model. This feedback loop uses a machine-learned classifier with a defined loss function, such as cross-entropy for categorical emotions or mean squared error for continuous emotion scores, and weight updates performed during offline training using gradient-based optimization. The server, during runtime, uses the trained model to compute emotion scores and applies deterministic mappings from scores to prompt modifications. This combination of learned emotion inference and rule-based prompt adjustment results in a technically improved system that adapts its generation instructions based on user sentiment in a way that reduces undesirable outputs and reduces the need for repeated manual correction by the user.

The server improves data management by storing associations between prompts, inputs, visual content data, and emotion analysis results in a persistent data structure. In one embodiment, the server uses a relational database schema containing tables for users, inputs, prompts, images, and emotion records, with foreign-key relationships linking entries. This structured storage enables efficient querying for histories, supports deduplication of similar content, and supports batch analysis of system performance. By structuring this data explicitly, the server supports technical capabilities such as rapid retrieval of prior results and efficient garbage collection or compression policies based on actual usage.

The server and terminal cooperate to reduce communication load. The server sends only identifiers and compact metadata when possible, while storing the full image data in a centralized storage. The terminal retrieves image data only when needed for display, and the server can adapt the format and resolution based on terminal capabilities. This adaptive behavior reduces unnecessary high-resolution transmission to terminals that cannot display such resolution, and thus improves bandwidth utilization.

The generative AI model used by the server is trained using a dataset of image-text pairs. During training, the server or a training environment computes a loss function that measures the discrepancy between generated images and target images or between predicted noise and actual noise in a diffusion process. The training environment updates model weights using an optimization algorithm such as stochastic gradient descent or an adaptive variant. The model's architecture, combining a text encoder and a denoising network, is selected to permit conditional generation driven by the prompt sentence. The server, at inference time, exploits this architecture to generate visual content that closely follows the structured and emotion-adjusted instructions encoded in the prompt.

In alternative embodiments, the server may use different types of generative AI models, such as generative adversarial networks or autoregressive models, while still using the same structured input processing, prompt generation, and emotion-based adaptation. The server may also vary the structure of the emotion analysis algorithm, for example by using a support vector machine or a decision-tree ensemble. Regardless of the specific model implementations, the server maintains the pipeline in which structured attribute data is transformed into a prompt sentence under predetermined sentence-structure rules and style conditions, and in which the prompt sentence is dynamically adjusted based on emotion scores.

The terminal can also vary in form. In one embodiment, the terminal is a smartphone running a mobile operating system, and the client application is a native application that interacts with device-specific sharing mechanisms. In another embodiment, the terminal is a personal computer running a web browser, and the client application is a web application that presents sharing options using web standards. In each case, the terminal executes instructions to display the visual content, to present the prompt sentence and related history, and to provide user operations for sharing.

The described embodiments illustrate how the server, the terminal, and the generative AI model are configured and cooperatively operate to implement the claimed system. Variations and modifications can be made without departing from the scope of the claims.

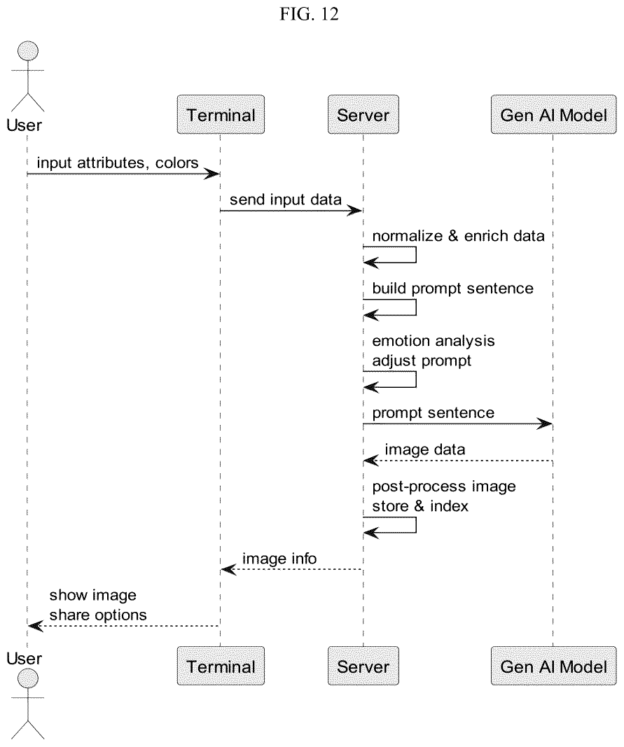

The following describes the processing flow using FIG. 12.

### Step 1

The terminal displays an input screen that includes text fields, selection boxes, and buttons for character attributes and color scheme. The input of this step is the current user interface state and any previously stored default values. The terminal reads these defaults from local storage or from an initialization message sent by the server and renders them on the display. The output of this step is a visible user interface that allows the user to specify appearance attributes (for example, accessories and hairstyle), personality attributes (for example, “cool” or “cheerful”), and color-related attributes (for example, “pink” or “blue”).

### Step 2

The user operates the terminal to input character-related attributes and color-related attributes into the displayed fields. The input of this step is the visual interface components provided by the terminal and any hints or examples shown on the screen. The user types text strings such as “cat ears” or “cool idol” into text fields, and selects items such as “pink” from a color list or color picker. The output of this step is raw input data captured by the terminal, including strings and selected options, which the terminal temporarily stores in its working memory.

### Step 3

The terminal converts the raw input data into structured data. The input of this step is the set of text strings and selected options obtained from the user interface widgets. The terminal creates an internal data object, for example with fields such as character_appearance, character_personality, and color_scheme, and copies each user-entered value into the corresponding field. The terminal performs basic formatting operations, such as trimming whitespace and converting characters to a standard case (for example, lowercase). The output of this step is structured input data ready for transmission to the server.

### Step 4

The terminal transmits the structured input data to the server via a communication interface. The input of this step is the structured data object produced in Step 3 and a network address or endpoint associated with the server. The terminal encodes the structured data into a request message according to a network protocol and sends the message through a network stack to the server. The output of this step is a network request containing the user's input information delivered to the server's communication interface.

### Step 5

The server receives and parses the request message containing the structured input data. The input of this step is the network request encapsulating the structured data. The server reads the request from a receive buffer, decodes the message format, and parses the data into an internal data structure in main memory. The server checks for syntax errors or missing fields and rejects or logs invalid requests when necessary. The output of this step is validated structured input data stored in the server's memory, organized into fields representing appearance attributes, personality attributes, and color-related attributes.

### Step 6

The server performs normalization processing on the character-related attributes. The input of this step is the validated structured input data containing free-form or partially standardized character attributes. The server applies rule-based mapping operations using lookup tables to convert synonymous expressions into canonical tokens; for example, the server maps “nekomimi” and “cat ears” to “cat_ears”, and maps “idol” and “performer” to “idol_character”. These operations involve table lookups and string replacements controlled by deterministic rules. The output of this step is a set of normalized character attributes represented by canonical identifiers.

### Step 7

The server performs normalization and standardization of the color-related attributes. The input of this step is the color-related portion of the structured data, such as “light pink” or “bright blue”. The server references a color dictionary stored in memory to map each input term to standardized color classification information, such as a canonical color name and associated numeric color parameters. The server executes dictionary lookups and, when necessary, interpolation or threshold comparisons to decide which standardized color each input maps to. The output of this step is standardized color classification information, including canonical color labels and compact numeric color representations.

### Step 8

The server performs attribute completion and enrichment. The input of this step is the normalized character attributes and standardized color classification information from Steps 6 and 7. The server evaluates correlation rules and default rules stored in a rule set to infer additional attributes when some attributes are missing or under-specified. For example, when the user specifies “cool idol” and “blue” without hairstyle information, the server consults correlation rules and may infer “short_hair” as a likely attribute. The server carries out rule evaluation using conditional checks and logical operations. The output of this step is an enriched structured data set that includes original attributes plus any inferred attributes.

### Step 9

The server constructs descriptive information based on the enriched structured data. The input of this step is the canonical attribute set and standardized color classification. The server concatenates tokens or text fragments corresponding to each attribute using template rules; for example, the server produces text such as “a cute idol character with cat ears and short hair” from the canonical attributes. The server inserts color-related phrases such as “using pink as the main color theme” based on the standardized color classification. The output of this step is a coherent descriptive phrase in natural language that integrates character attributes and color information.

### Step 10

The server generates a prompt sentence for the generative AI model by combining the descriptive information with style conditions. The input of this step is the descriptive phrase from Step 9 and style configuration data that may specify aspects such as “anime style”, “high resolution”, “full-body view”, or “simple background”. The server fills a sentence template using these components, adding connective words and ordering clauses according to predetermined sentence-structure rules. For example, the server outputs a sentence such as “Please generate a high-resolution anime-style illustration of a cute idol character with cat ears and short hair, using pink as the main color theme, standing in front of a simple background.” The output of this step is a complete prompt sentence represented as a text string stored in memory.

### Step 11

The server applies an emotion analysis algorithm and optionally adjusts the prompt sentence. The input of this step is the prompt sentence from Step 10 and emotion-related input information obtained from the user or derived from user interaction history. The server converts the emotion-related information into feature vectors and feeds them into an emotion classifier, which outputs emotion scores or labels. The server uses these scores to modify elements of the prompt sentence, for example changing “using pink as the main color theme” to “using a soft pink as the main color theme” for a calm emotion or “using a vivid pink as the main color theme” for an excited emotion, and adjusting style descriptors such as “dynamic” or “minimalist”. The output of this step is an emotion-adjusted prompt sentence that maintains the core attributes but adapts tone and style.

### Step 12

The server encodes the adjusted prompt sentence and invokes the generative AI model. The input of this step is the final prompt sentence and configuration parameters such as target resolution, number of inference steps, and guidance scale. The server passes the prompt sentence to a text encoder component that tokenizes the text and converts tokens into embeddings using a neural network, and then provides these embeddings, along with random noise tensors and the configuration parameters, to a denoising network or similar generative architecture. The server instructs a GPU to execute matrix multiplications and convolution operations that iteratively transform the noise tensor into an image tensor conditioned on the prompt embeddings. The output of this step is an image tensor representing visual content that corresponds to the prompt sentence.

### Step 13

The server converts the image tensor into visual content data in a chosen image format. The input of this step is the image tensor consisting of numeric pixel values generated by the generative AI model. The server applies normalization of pixel values, color space conversion if necessary, and image encoding routines that compress the pixel data into a file format such as a compressed bitmap. The server may also attach metadata describing resolution, color profile, and generation parameters. The output of this step is visual content data stored as an image file or byte stream.

### Step 14

The server performs post-processing to adapt the visual content data to terminal capabilities. The input of this step is the encoded image file and information about the requesting terminal, such as supported resolution and preferred formats. The server scales the image to a suitable size, changes or optimizes the encoding scheme (for example, adjusting compression quality), and selects an appropriate storage format. These operations involve resampling pixel arrays and re-encoding the image. The output of this step is post-processed image data that is optimized for display and transmission to the terminal.

### Step 15

The server stores and indexes the relationship between the visual content data, the prompt sentence, and the input information. The input of this step is the post-processed image data, the final prompt sentence, the structured input data, and optional emotion analysis results. The server writes records into a persistent data store, linking an image identifier to associated text fields and user identifiers. The server may also generate and store a network-accessible identifier for later retrieval. The output of this step is an updated database or storage index that enables efficient retrieval of the image and its generation context.

### Step 16

The server transmits the post-processed visual content data or its identifier to the terminal. The input of this step is the optimized image data and the terminal's network address or session information. The server constructs a response message containing either the binary image data or a resource identifier that the terminal can use to fetch the image, together with metadata such as the prompt sentence and relevant attributes. The server sends this message through the communication interface. The output of this step is a response received at the terminal side that contains all information required to display and manage the generated content.

### Step 17

The terminal receives the response and prepares the visual content for display. The input of this step is the response message from the server containing the image data or image identifier and associated metadata. The terminal decodes the message, and, if an identifier is provided, requests the corresponding image from the specified resource. The terminal then decodes the image data into a pixel buffer suitable for rendering. The output of this step is a decoded image stored in the terminal's memory and associated textual information such as the prompt sentence and attributes.

### Step 18

The terminal displays the visual content and associated information to the user. The input of this step is the pixel buffer and metadata prepared in Step 17. The terminal issues drawing commands to its graphics subsystem to render the image on the display device and arranges text elements, such as the prompt sentence and attribute summaries, within the user interface. The terminal can also write a history record in local storage linking the image view to the originating request. The output of this step is a visible visual content item on the terminal's display and a stored local history entry.

### Step 19

The terminal presents sharing options and receives further user operations. The input of this step is the current display state showing the visual content and metadata, and any sharing configuration it has received from the server. The terminal generates user interface elements, such as buttons labeled “Share”, “Copy link”, or “Save”, and lays them out on the screen. The user may then select a sharing option, and the terminal packages identifiers or links as needed for external applications or network services. The output of this step is one or more user-initiated actions that may trigger additional network requests or local operations, enabling the user to distribute the generated visual content while preserving the association with the underlying prompt sentence and attributes.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented image generation systems that use generative AI models typically accept a simple, unstructured text input from a user and directly pass that text as a prompt to the model. Such systems often treat the prompt as an opaque string without performing fine-grained natural language processing, semantic structuring, or systematic conversion into model-optimized numerical representations. As a result, the generated visual output frequently fails to accurately reflect nuanced user intent, especially when the user specifies multiple characteristics, colors, or abstract design requirements. This leads to inefficiencies such as repeated trial-and-error prompt editing, increased computation time, and unnecessary consumption of processing resources.

Moreover, many existing systems are designed primarily as content generators and do not integrate downstream workflows that make the generated visual expressions immediately actionable. For example, conventional systems generally do not provide automatic, stepwise instructions for using the generated visual expressions to create physical or digital decorative articles, nor do they systematically convert the generated visual expressions into low-resolution dot patterns optimized for use as identification images in communication network services. Accordingly, the user must manually perform additional editing, formatting, and adaptation steps using separate applications, which increases cognitive load and introduces inconsistencies in quality.

Additionally, current systems do not sufficiently exploit user-related contextual information, such as sentiment, in a structured computational manner to control color tone or other visual parameters of generated images. Although sentiment analysis algorithms exist as separate components, they are rarely integrated into the core pipeline of generative AI-based image synthesis. This lack of integration prevents dynamic adjustment of generated images based on real-time emotional context of the user and limits the ability of the system to provide personalized outputs that are both semantically accurate and emotionally aligned.

Thus, there is a need for a computer-implemented technique that improves the internal processing pipeline of a generative AI-based image generation system by: (i) systematically transforming user-specified characteristics and colors into structured prompt sentences and model-optimized numerical embeddings; (ii) integrating sentiment analysis into the image generation workflow to control visual properties such as color tone; and (iii) automatically generating actionable instructions and format conversions that allow the resulting abstract visual expressions to be readily used as decorative articles and identification images in communication network services. Such a technique should improve the technical functioning of the overall computer system by reducing ineffective generations, decreasing manual post-processing, and enhancing the relevance and usability of generated visual content.

The specific processing by the specific processing unit 290 of the data processing device 12 in Example 2 is realized by the following means.

The present invention provides a server comprising a processor configured to receive, via a terminal, a plurality of pieces of information regarding characteristics and colors of a target from a user, generate a prompt sentence in a natural language based on the plurality of pieces of information, convert the prompt sentence into a structured prompt suitable for input to a generative AI model, apply a natural language processing algorithm to the prompt sentence to extract keywords and attributes, convert the prompt sentence into numerical data by generating an input embedding vector for the generative AI model based on an extraction result, input the embedding vector to the generative AI model and generate image data representing an abstract visual expression corresponding to the user input by executing iterative numerical computation including matrix computation and nonlinear computation in the generative AI model, adjust a color tone of the generated image data based on an analysis result of a sentiment analysis algorithm that analyzes a sentiment of the user, encode the color-tone-adjusted image data into a predetermined image format and provide the encoded image data in a format transmittable to the terminal via a network, generate, based on the prompt sentence and feature information regarding the generated abstract visual expression, stepwise operation instructions representing creation procedures of a decorative article using the abstract visual expression and present the stepwise operation instructions to the user via the terminal, and convert the generated abstract visual expression into a pixel-level pattern, output the pixel-level pattern as a low-resolution dot representation, and provide the low-resolution dot representation to the terminal in a format usable as an identification image in a communication network service. This enables improvement of the technical operation of a computer-based image generation system by optimizing the transformation from user input to model-ready numerical representations, by dynamically controlling visual parameters of generated images based on user sentiment within the same processing pipeline, and by automatically producing structured instructions and format-converted outputs that reduce manual post-processing and allow efficient, direct use of the generated abstract visual expressions in downstream applications.

The term “processor” refers to a hardware information processing element, such as a central processing unit or graphics processing unit, that executes instructions to perform arithmetic operations, control operations, and data processing operations according to a program.

The term “terminal” refers to an information processing apparatus, such as a computing device or communication device, that is operated by a user to input information to a server and to receive and display information from the server via a communication network.

The term “user” refers to a human operator who interacts with the system through the terminal by providing input information and receiving output information.

The term “target” refers to an object, concept, or subject matter for which an abstract visual expression is to be generated based on characteristics and colors specified by the user.

The term “characteristics” refers to features, attributes, or properties of the target, including shapes, motifs, patterns, or conceptual elements that the user desires to be reflected in the generated abstract visual expression.

The term “colors” refers to visual attributes related to hue, saturation, brightness, or tone that are specified by the user and are to be applied to the generated abstract visual expression.

The term “prompt sentence” refers to a text string expressed in a natural language, generated based on user-specified information, that describes desired characteristics and colors of the target and is used as an input instruction for a generative AI model.

The term “structured prompt” refers to a representation of a prompt sentence that has been transformed into a structured or standardized format, including, for example, organized keywords, tags, or fields, which is optimized for input to a generative AI model.

The term “generative AI model” refers to a machine learning model that, given one or more inputs including a prompt, generates new data, such as image data representing an abstract visual expression, based on learned parameters.

The term “natural language processing algorithm” refers to a software-implemented procedure that analyzes text expressed in a natural language, including operations such as tokenization, part-of-speech tagging, and extraction of keywords and attributes, to derive structured information from the text.

The term “keywords” refers to words or phrases extracted from a prompt sentence that represent important concepts, objects, or features relevant to the generation of an abstract visual expression.

The term “attributes” refers to qualifying elements extracted from a prompt sentence, such as color, style, or emotional tone, that modify or specify characteristics of the abstract visual expression to be generated.

The term “input embedding vector” refers to a numerical vector or tensor that encodes semantic information of a prompt sentence, generated by applying a transformation such as a neural network to the text, and used as conditioning input to a generative AI model.

The term “numerical data” refers to data expressed in a numerical format, such as real-valued vectors or tensors, that is suitable for mathematical operations performed by a generative AI model.

The term “iterative numerical computation” refers to a sequence of repeated mathematical operations, including matrix computation and nonlinear computation, executed by a generative AI model to progressively refine an internal representation until a final output is obtained.

The term “matrix computation” refers to numerical operations performed on matrices, such as matrix multiplication, addition, or transformation, used within layers of a generative AI model.

The term “nonlinear computation” refers to numerical operations that apply nonlinear functions, such as activation functions or normalization functions, to numerical data within a generative AI model.

The term “abstract visual expression” refers to a visual representation, including an image, symbol, logo, or monogram, that does not directly depict a realistic object but instead expresses concepts, characteristics, or emotions in a stylized or symbolic form.

The term “image data” refers to digital data representing a visual image, including, for example, pixel values or encoded image formats, generated by the system as a result of processing by the generative AI model.

The term “sentiment analysis algorithm” refers to a software-implemented procedure that analyzes user-related information, such as text input, to estimate an emotional state or sentiment category associated with the user.

The term “color tone” refers to one or more parameters defining the visual appearance of colors in image data, including hue, saturation, brightness, and contrast, which can be adjusted to change the overall atmosphere of the image.

The term “analysis result” refers to information output by an algorithm, such as a sentiment analysis algorithm, representing a computed evaluation, classification, or score derived from input data.

The term “encode” refers to the process of converting raw image data into a specific file format, such as a bitmap format or compressed format, according to a predetermined encoding scheme.

The term “predetermined image format” refers to an image file format defined in advance by the system, such as a standard raster format or compressed format, suitable for storage, transmission, and display.

The term “network” refers to a communication infrastructure, such as a wired or wireless communication network, that enables data exchange between the server and the terminal.

The term “feature information” refers to structured information describing properties of a generated abstract visual expression, such as identified motifs, colors, styles, or layout elements, derived from or associated with the image data.

The term “stepwise operation instructions” refers to a sequence of ordered procedural steps that specify operations to be performed by a user for creating or using a decorative article based on a generated abstract visual expression.

The term “decorative article” refers to a physical or digital item used for decoration or expression of preference, such as an accessory, printed material, sticker, or digital asset, incorporating the abstract visual expression.

The term “pixel-level pattern” refers to a representation of an image as a discrete arrangement of picture elements, each having at least one value, such as color or brightness, suitable for low-resolution rendering.

The term “low-resolution dot representation” refers to an image representation in which the abstract visual expression is rendered as a coarse grid of dots or pixels with relatively few picture elements, suitable for simplified display or icon-type usage.

The term “identification image” refers to an image used to visually identify a user, account, or entity within a communication network service, including, for example, icons, avatars, or profile images.

The term “communication network service” refers to an information service provided over a network, such as a messaging service, social networking service, or online community, in which users exchange information and use identification images.

The server, the terminal, and the user cooperate to implement embodiments of the present invention. In each embodiment, the server is realized by one or more information processing devices including at least one processor, a main memory, a non-volatile storage device, and a network interface. The terminal is realized by a computing device such as a smartphone, a tablet, or a personal computer equipped with an input/output interface and a display. The user operates the terminal to provide input to, and receive output from, the server via a communication network.

The server executes an operating system such as a general-purpose server operating system and runs application software including a web server module, an application logic module, and one or more machine learning modules. The server stores program instructions and trained parameter data for a generative AI model in a storage device such as a solid-state drive. The server loads necessary program modules and model parameters into the main memory and, when available, into a graphics processing unit (GPU) memory to accelerate numerical computation.

The terminal executes an operating system such as a mobile or desktop operating system and runs a client application or web browser. The terminal includes a display unit, an input unit such as a touch panel or keyboard, a communication unit such as a wireless or wired network interface, and a storage unit. The terminal presents a user interface that allows the user to input a prompt sentence and to view an abstract visual expression generated by the server.

The user operates the terminal to access a user interface screen provided by the server. The user inputs textual information describing characteristics and colors of a target to be visually expressed. The user may input, for example, the following prompt sentences in plain text:
“Please generate a monogram that combines cat-ear features and the color pink.”
“Please generate a monogram with cat ears, pink and gold colors, and a circular frame.”
“Generate three abstract logos that express elegance using cat ears and pastel pink.”
“Create an abstract visual pattern that expresses calmness using pastel pink and a small cat-ear symbol in the center.”

The terminal acquires the text entered by the user via the input unit, temporarily stores it in a memory area of the terminal, and transmits the text to the server through the communication unit over a network using a communication protocol such as HTTPS. The terminal may additionally transmit auxiliary information such as a user identifier, device identifier, and language setting. The use of a structured communication protocol and explicit text payloads permits reliable and secure transfer of the prompt sentence and associated metadata.

The server receives the text data sent from the terminal through the network interface. The server passes the received data to an application logic module executed by the processor. The server stores the prompt sentence into a request-specific data structure in main memory. The server may assign the prompt sentence to a field of a structured object, together with timestamps and session identifiers, and manages these objects in a request queue. This explicit organization of incoming data improves data management and facilitates concurrent processing of multiple user requests in a scalable manner.

The server performs natural language processing on the prompt sentence using a natural language processing algorithm implemented, for example, with a language model library executing on the processor or GPU. The server tokenizes the prompt sentence into discrete tokens, assigns part-of-speech tags, and performs dependency parsing to identify relationships among tokens. The server then extracts keywords, such as “monogram” and “cat ears,” and attributes, such as “pink,” “gold,” “circular frame,” and “pastel,” from the syntactic and dependency structure. In some embodiments, the server maps extracted tokens to entries of a controlled vocabulary stored in a database, thereby standardizing synonyms and reducing variation. By converting natural language into a structured representation including normalized keywords and attributes, the server reduces ambiguity and improves the accuracy of subsequent embedding generation.

The server constructs a structured prompt by organizing the extracted keywords and attributes into a data structure that explicitly separates categories such as target type, motif, color, style, and layout. For example, the server may construct a record having fields such as [object_type: monogram], [motif: cat ears], [color_primary: pink], [color_secondary: gold], [layout: circular frame], [style: abstract, elegant]. The server may store this structured prompt in a machine-readable format in memory. This structured prompt formation constitutes a non-conventional transformation of unstructured text into an internal representation tailored to the architecture of the generative AI model, thereby improving the technical performance of the model input interface.

The server then converts the structured prompt into numerical data suitable for input to a generative AI model. The server loads a text encoder component of a neural network model into GPU memory and transforms the tokenized text into embedding vectors. The text encoder may be a transformer-based architecture having multiple self-attention layers and feed-forward layers, each comprising matrix multiplications and nonlinear activation functions. The server represents the prompt sentence as a sequence of token identifiers, looks up each token identifier in an embedding matrix, and applies positional encoding. The server then processes the sequence through stacked attention layers to generate a final embedding vector that captures semantic relations among keywords and attributes.

The server uses this embedding vector as an input condition to a generative AI model. The generative AI model may be realized as a diffusion-based image generation model having a latent-space representation and a neural network including a U-shaped convolutional network (U-Net) that operates on latent feature maps. The server initializes a latent tensor as random noise and iteratively refines the latent tensor through multiple denoising steps. In each step, the server passes the current latent tensor and the prompt embedding vector to the U-Net, which outputs an estimated noise tensor. The server updates the latent tensor by subtracting a scaled version of the estimated noise according to a predetermined denoising schedule. The server repeats this operation over many steps to approximate the solution of a diffusion process defined by a learned noise prediction function.

The server executes these matrix and convolution operations using a machine learning framework running on the GPU. This framework organizes the computations as tensor operations and uses highly optimized linear algebra libraries. By performing the diffusion process in latent space and conditioning it on a text embedding, the server achieves a high-quality abstract visual expression while reducing the computational load compared to directly operating in pixel space. This reduces processing time and memory usage for each generation request.

The server further integrates a sentiment analysis algorithm into this generation pipeline. The server receives sentiment-related input such as additional text describing the user's mood or a history of prompt sentences. The server applies a sentiment classifier, for example a neural network trained using supervised learning with labeled sentiment categories. The sentiment classifier outputs a sentiment score or category, such as positive, neutral, or negative, and possibly a continuous intensity value. The server uses this sentiment information to calculate color tone adjustment parameters, including hue shifts, saturation scaling, and brightness scaling. For example, for a positive sentiment, the server may increase saturation and brightness within a predetermined range, whereas for a calm sentiment, the server may decrease saturation and shift hue toward cooler tones.

The server applies the color tone adjustment parameters to the generated image data. After decoding the latent tensor into an RGB image using a decoder network such as a variational autoencoder decoder, the server modifies the pixel values according to the color adjustment parameters. The server operates on the pixel data using color space transformations, for example converting from RGB to HSV or HSL space, adjusting the corresponding components, and converting back to RGB. This integrated adjustment based on sentiment analysis provides a technical advantage by producing images that are not only semantically aligned with the prompt, but also consistently modulated to match the user's emotional context, without requiring manual color correction by the user. From a system perspective, this integrated approach reduces the number of regeneration cycles and network round-trips needed to obtain a satisfactory result, thereby lowering processing and communication load.

The server encodes the color-tone-adjusted image data into a predetermined image format, such as a compressed raster format, using an image processing library. The server may generate multiple resolutions of the same image, such as a full-size version and a thumbnail. The server stores the encoded image file in a storage device, associates it with metadata including the original prompt sentence, structured prompt, embedding parameters, and sentiment analysis result, and registers a reference to the file in a database. This structured storage of image data together with generation parameters enhances data management and enables efficient retrieval, auditing, and re-generation with modified parameters.

The terminal receives a notification or response from the server containing either the encoded image data or an access location to the stored image data. The terminal decodes the image if necessary and displays the abstract visual expression on the display unit. The user observes the image and can immediately evaluate whether the image conforms to the desired characteristics, colors, and emotional tone. The terminal may present interface elements for saving, sharing, or requesting further modifications. The ability to present images that are generated through an optimized, sentiment-aware pipeline reduces the need for repetitive user interactions and enhances the overall responsiveness of the system.

In some embodiments, the server generates, in addition to the image data, stepwise operation instructions for creating decorative articles based on the generated abstract visual expression. The server uses the structured prompt and feature information extracted from the generated image, such as dominant color regions, motif positions, and aspect ratio, to determine how the image may be applied to physical or digital items. The server constructs a sequence of steps, for example “print the monogram at a specified size,” “cut along a particular contour,” or “affix the design to a substrate,” and formats these as text suitable for display on the terminal. By computing these instructions in a structured manner, the server transforms the generated abstract visual expression into concrete procedural guidance, which is technically linked to the internal representation of the image and not merely a generic manual. This reduces the cognitive and operational load on the user and ensures consistent application of the generated image in downstream processes.

In other embodiments, the server converts the generated abstract visual expression into a pixel-level pattern suitable for use as a low-resolution dot representation. The server constructs a reduced-resolution grid, maps the high-resolution image onto this grid using down-sampling and quantization procedures, and produces a pattern of discrete dot values. The server may restrict the color palette to a small set of values to optimize for display constraints of communication network services that handle icons or avatars. The server encodes this low-resolution dot representation in a compact format and transmits it to the terminal. The terminal displays the dot representation as an identification image for use in communication network services. This embodiment provides a technical effect by automatically adapting a complex generated image to the constraints of identification image use, improving compatibility with limited-resolution and limited-bandwidth environments, and reducing the need for manual resizing and reformatting operations.

The server applies a specific machine learning training procedure to the generative AI model used in these embodiments. During an offline training phase, the server or another computer trains the model using a large dataset of pairs of textual descriptions and images. The server defines a loss function that measures the discrepancy between model-predicted noise or tokens and ground-truth values, and updates the model's weights by gradient-based optimization such as stochastic gradient descent or an adaptive gradient method. The server may employ data augmentation, such as random cropping, color jitter, or text paraphrasing, to improve generalization. The trained model parameters are stored in a storage device and loaded by the server at inference time. Because the model is trained to operate on structured prompts and embeddings, the runtime transformation of prompts into structured representations and embeddings enables more accurate and efficient inference than a generic text-to-image pipeline.

The server also applies a dedicated training or calibration process for the sentiment analysis algorithm. The server uses labeled datasets of text and associated sentiment labels to train a classifier network. The classifier network learns parameters that map textual features to sentiment classes or scores. During integration with the image generation pipeline, the server uses these calibrated sentiment scores to calculate color-tone adjustment parameters through predefined mapping functions. This defined mapping ensures predictable and repeatable color behavior, which is important when the generated images are used as identification images or decorative articles with branding implications.

The system improves computer technology in several ways. First, by introducing the structured prompt and embedding generation layer between the raw prompt sentence and the generative AI model, the server reduces ambiguity and inconsistency in model conditioning, leading to fewer failed or irrelevant generations. This reduces computational load and latency, because fewer high-cost inference iterations are needed. Second, by integrating sentiment analysis as a direct input to color-tone adjustment, the server offloads a class of manual post-processing operations to an algorithmic pipeline, while controlling image parameters in a mathematically defined manner. This alignment between semantic and emotional aspects of the image reduces the number of correction cycles and server-client communications. Third, by automatically generating low-resolution dot representations and stepwise operation instructions, the server provides outputs that are already adapted to downstream devices and services, thereby decreasing the need for further transformation and lowering the total processing and communication overhead across the entire usage chain.

The server performs these operations according to explicit rules and numerical procedures that differ from conventional manual workflows. The server does not simply mimic human reasoning; instead, the server applies specific numerical algorithms, data structures, and model architectures-such as transformer-based text encoders, diffusion-based latent-space generators, and neural sentiment classifiers-to implement transformations that are impractical to achieve reliably by human operation alone. The combination of structured prompt construction, embedding-based conditioning, integrated sentiment-based color modulation, and automatic generation of actionable formats constitutes a specific improvement to the functioning of the computer-based image generation system as a whole.

The terminal, in these embodiments, functions not only as a passive display but also as a controller for the flow of prompt sentences and visual feedback. The terminal manages local caching of results, supports interactive refinement of prompt sentences, and may provide local pre-processing, such as language input assistance or validation, prior to sending data to the server. This local processing can further reduce unnecessary network traffic and server load. The user, by following the instructions presented on the terminal, can use the generated abstract visual expressions to create physical decorative articles or to configure identification images in communication network services, thereby linking the computer-implemented processing to concrete uses in the real world.

Multiple variations of these embodiments are possible. The server may employ different neural network architectures for the generative AI model, such as auto-regressive token generators, adversarial networks, or hybrid models, while still using structured prompts and embeddings as conditioning inputs. The server may change the resolution, aspect ratio, or color space of the generated image according to device characteristics or service requirements. The server may adjust the mapping from sentiment scores to color-tone parameters according to application profiles, such as a profile for business use or personal use. The terminal may be a dedicated application device, such as a kiosk or embedded system, rather than a general-purpose personal device. These variations can be combined as appropriate, as long as the core features-structured prompt generation, embedding-based conditioning of a generative AI model, sentiment-based color adjustment, and automatic generation of formats adapted for decorative articles and identification images-are implemented by the server in cooperation with the terminal and the user.

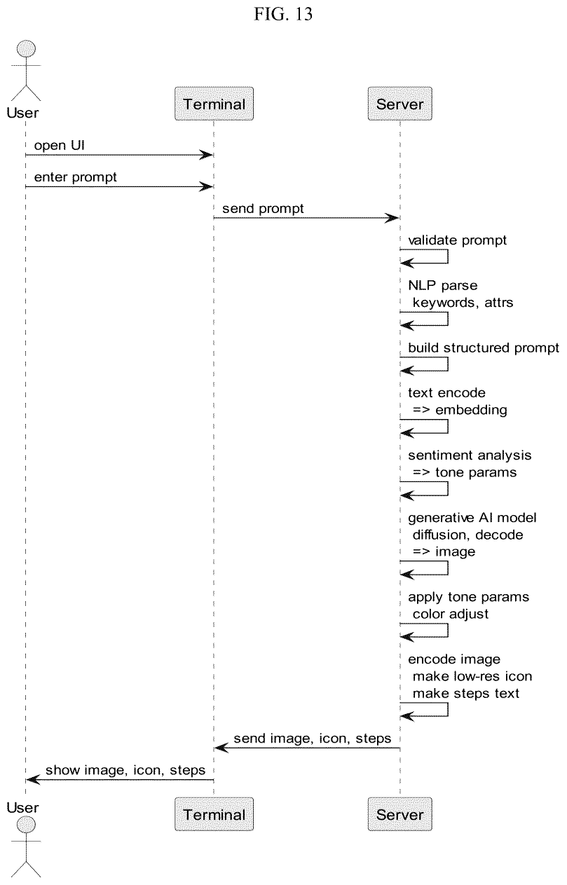

The following describes the processing flow using FIG. 13.

### Step 1

The user operates the terminal to open an application or web page that provides an input screen. The terminal receives a text input from the user via a keyboard or touch interface. The input is a prompt sentence describing desired characteristics and colors, such as “Please generate a monogram that combines cat-ear features and the color pink.” The terminal stores this prompt sentence as character string data in a local buffer. The terminal then constructs a request message, sets the prompt sentence as an input field in the message, and transmits the message to the server over a network using a communication protocol such as HTTPS. The output of this step is a network request containing the prompt sentence and optional metadata.

### Step 2

The server receives the network request via a network interface and passes the request to an application module. The input of this step is the request containing the prompt sentence and metadata. The server parses the request, extracts the prompt sentence, and performs validation, such as checking that the length is within a predefined limit and that prohibited characters are not included. The server normalizes the text by trimming spaces and unifying character encodings. The server stores the normalized prompt sentence in a request-specific data structure in memory. The output of this step is a validated and normalized prompt sentence ready for linguistic analysis.

### Step 3

The server applies a natural language processing algorithm to the normalized prompt sentence. The input of this step is the normalized prompt sentence. The server tokenizes the sentence into tokens, assigns part-of-speech tags, and performs dependency parsing using a language processing library. The server identifies and extracts keywords such as “monogram” and “cat ears,” and attributes such as “pink,” “gold,” and “circular frame.” The server filters out auxiliary words that are not relevant to the generative AI model. The server stores the extracted keywords and attributes in a structured data object, such as a list or dictionary. The output of this step is a set of structured linguistic features representing the user's intent.

### Step 4

The server converts the structured linguistic features into a structured prompt. The input of this step is the set of extracted keywords and attributes. The server assigns each keyword and attribute to predefined fields, such as object type, motif, primary color, secondary color, layout, and style. The server constructs a structured record, for example [object_type: monogram], [motif: cat ears], [primary_color: pink], [secondary_color: gold], [layout: circular frame], [style: abstract]. The server may store this record as a key-value data structure in memory. The output of this step is a structured prompt optimized for further numerical processing.

### Step 5

The server generates an embedding vector from the structured prompt for use by the generative AI model. The input of this step is the structured prompt. The server converts the structured prompt back into a canonical prompt sentence that emphasizes normalized terms, such as “abstract monogram with cat ears, pink and gold colors, circular frame.” The server encodes this canonical prompt sentence into token IDs using a tokenizer associated with a text encoder network. The server looks up embedding vectors for each token, applies positional encoding, and propagates the token sequence through a multi-layer neural network with attention and feed-forward layers. The numerical operations include matrix multiplications, attention score calculations, and nonlinear activations. The server aggregates the token outputs into a single high-dimensional embedding vector. The output of this step is an embedding vector that numerically represents the semantic content of the prompt sentence.

### Step 6

The server performs sentiment analysis on user-related text to derive parameters for color adjustment. The input of this step is sentiment-related text data such as an additional comment from the user or historical prompt sentences. The server tokenizes and encodes the sentiment-related text and feeds it into a sentiment classifier network. The classifier applies multiple layers of linear and nonlinear transformations to compute a sentiment score or category. The server then maps the sentiment result to numerical parameters defining color tone adjustments, such as saturation scaling factors and hue shift values. The server stores these parameters in association with the current request. The output of this step is a set of color tone adjustment parameters to be applied to the generated image.

### Step 7

The server generates an abstract visual expression using the generative AI model. The inputs of this step are the embedding vector from the canonical prompt sentence and generation configuration parameters such as number of steps and latent space size. The server initializes a latent tensor with random noise. The server repeatedly executes a denoising neural network that receives the current latent tensor and the embedding vector as inputs. In each iteration, the server performs convolution operations, attention operations, and nonlinear activations on the GPU to predict noise components. The server updates the latent tensor by subtracting a scaled version of the predicted noise according to a diffusion schedule. After a predefined number of iterations, the server obtains a refined latent tensor that encodes the abstract visual expression. The output of this step is a latent representation of the image data.

### Step 8

The server decodes the latent representation into full-resolution image data. The input of this step is the latent tensor from the generative AI model. The server passes the latent tensor through a decoder network, such as a variational autoencoder decoder, that applies up-sampling and convolution layers to reconstruct a three-channel image array. The server transforms the decoder output into a two-dimensional array of RGB values, normalizes values to a valid range, and converts floating-point values to integer pixel values. The output of this step is raw image data that visually represents the abstract visual expression corresponding to the user's prompt sentence.

### Step 9

The server adjusts the color tone of the generated image data based on the sentiment analysis result. The inputs of this step are the raw image data and the color tone adjustment parameters derived from sentiment analysis. The server converts each pixel's RGB value into a different color space such as HSV or HSL, applies numerical operations to adjust hue, saturation, and brightness according to the parameters, and converts the adjusted values back to RGB. The server processes all pixels sequentially or in parallel using vectorized operations. The output of this step is color-adjusted image data that reflects both the semantic content of the prompt and the user's emotional context.

### Step 10

The server encodes and stores the color-adjusted image data for transmission and reuse. The input of this step is the color-adjusted image data. The server uses an image encoding library to compress the image data into a predetermined image format such as a compressed raster format. The server may generate multiple variants, such as different resolutions or aspect ratios, by applying resizing algorithms. The server stores the encoded files in non-volatile storage and records corresponding metadata including prompt sentences, embedding identifiers, and sentiment parameters in a database. The output of this step is at least one encoded image file and associated metadata accessible by an identifier or URL.

### Step 11

The server generates stepwise instructions for creating decorative articles based on the generated abstract visual expression. The inputs of this step are feature information extracted from the image, such as motif regions, main color blocks, and image dimensions, and the structured prompt. The server analyzes the image feature data using image processing methods such as contour detection and color clustering. The server then composes a sequence of textual instructions, such as “print the image at a specified size,” “cut along the outer circular frame,” and “attach the cut-out monogram to a surface.” The server stores these instructions as a list of steps. The output of this step is a textual description of stepwise operation instructions suitable for presentation on the terminal.

### Step 12

The server generates a low-resolution dot representation for use as an identification image. The input of this step is the color-adjusted image data. The server downsamples the image to a low resolution grid, such as 32×32 pixels, using interpolation or averaging. The server quantizes the color values to a limited palette to reduce complexity. The server arranges the quantized pixels into a pixel-level pattern and may encode this pattern in a compact format. The output of this step is a pixel-level pattern representing a low-resolution dot image that is suitable for icons or profile images in communication network services.

### Step 13

The server sends the encoded images, the low-resolution dot representation, and the stepwise instructions to the terminal. The inputs of this step are identifiers or data for the encoded images, pixel-level pattern, and textual instructions. The server constructs a response message, embeds URLs or binary data for the images, and includes the text of the stepwise instructions. The server transmits the response message over the network to the terminal. The output of this step is a network response that carries all generated data required by the terminal.

### Step 14

The terminal receives the response message from the server and processes its contents. The input of this step is the network response containing image references, pixel-level pattern data, and textual instructions. The terminal parses the response, downloads the encoded image files if necessary, decodes them into displayable image data, and allocates display components in the user interface. The terminal renders the main abstract visual expression, the low-resolution dot representation, and the textual stepwise instructions on the display. The output of this step is a set of on-screen visual and textual elements that the user can view and use.

### Step 15

The user views the generated abstract visual expression, the low-resolution dot representation, and the presented instructions on the terminal display. The input of this step is the displayed content. The user evaluates whether the images and instructions satisfy the intended design and emotional impression conveyed by the original prompt sentence. The user may then decide to save the images to local storage, apply the dot representation as an identification image in a communication network service, or follow the stepwise instructions to create a decorative article in the physical world. The output of this step is a human decision and subsequent action based on the technical processing performed by the server and the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that utilize a generative AI model primarily focus on converting a user's textual input into an image, logo, or other visual asset. Such systems typically treat the user's input as static descriptive data and ignore dynamic contextual signals such as the user's emotional state or downstream fabrication constraints. As a result, the generated visual content is often poorly aligned with the user's actual affective condition, and thus fails to provide a deeply personalized experience. In addition, conventional pipelines do not natively transform the generated visual content into machine-derivable patterns, material specifications, or procedural instructions that can be efficiently consumed by peripheral applications and devices, such as craft design tools, printing pipelines, or merchandise configuration systems.

From a computer-technology standpoint, conventional architectures lack: (i) an integrated mechanism in the server for constructing a prompt sentence that explicitly encodes both multi-type feature information and color attribute information; (ii) a server-side control loop that feeds emotion analysis results back into the generative AI model invocation and/or into deterministic post-processing of the generated image data; and (iii) a server-side pattern-conversion and materials-calculation engine that converts high-resolution abstract visual information into lower-resolution pattern data suitable for constrained displays or craft devices, together with structured material information and procedural instructions. Consequently, existing systems tend to rely on manual, error-prone, and computationally inefficient post-processing steps, and cannot provide a unified, automated pipeline from multi-modal user input, through emotion-aware generative AI processing, to structured outputs suitable for downstream digital and physical item creation.

Therefore, there is a need for an improved computer-implemented system and server that: automatically constructs prompt sentences from heterogeneous user inputs; performs emotion analysis on textual, audio, and image data; feeds the resulting emotion information back into prompt construction and/or image post-processing; programmatically converts generated visual information into reduced-resolution pattern data; and derives structured material information and stepwise creation instruction information. Such a system should improve the operation of the computer itself by organizing data flows and computations in a way that reduces manual intervention, enforces consistent data structures, and enables new types of programmatic integration with external applications and devices.

The specific processing by the specific processing unit 290 of the data processing device 12 in Application Example 2 is realized by the following means.

The present invention provides a server comprising a processor configured to receive, via a terminal, multiple types of feature information and color attribute information from a user, construct, based on the feature information and the color attribute information, a prompt sentence as generation instruction text, transmit input data including the prompt sentence to a generative AI model, and acquire abstract visual information in the form of image data or symbolic design data from the generative AI model; apply an emotion analysis algorithm to text information, voice information, or image information acquired from the user to estimate an emotional state of the user and specify emotion information; modify, in accordance with the emotion information, at least one of content of the prompt sentence supplied to the generative AI model and color characteristics or brightness characteristics of the image data or the symbolic design data acquired from the generative AI model so as to adjust the abstract visual information to become a visual expression adapted to the emotional state of the user; analyze pixel information of the adjusted abstract visual information to generate pattern data having a reduced resolution and a quantized number of colors, and calculate material information including a material type and a required quantity based on a number of pixels for each color; generate creation instruction information describing, as stepwise procedures, a production process for creating a product or an activity article using the adjusted abstract visual information and the pattern data; and provide the adjusted abstract visual information, the pattern data, the material information, and the creation instruction information to the terminal in a displayable format via a communication network. This enables an integrated, computer-implemented pipeline in which the server automatically converts heterogeneous user inputs and emotion signals into emotion-aware prompt sentences for a generative AI model, programmatically post-processes the generated abstract visual information into machine-derivable pattern data and structured material and instruction outputs, and supplies these outputs in a consistent, readily consumable format to the terminal and to external applications, thereby improving the operation and usefulness of the underlying computing system.

The term “processor” refers to a hardware or virtual computation unit, such as a central processing unit, graphics processing unit, or logical processing core, that executes instructions to perform data acquisition, analysis, generation, and transmission in accordance with stored programs.

The term “terminal” refers to an information processing apparatus, such as a mobile device, tablet, head-mounted device, or personal computer, that provides a user interface for inputting information and for displaying information received from a server.

The term “feature information” refers to information that represents attributes or characteristics of a subject, such as appearance traits, patterns, shapes, or conceptual properties, which are input by a user and used as a basis for generating visual content.

The term “color attribute information” refers to information indicating one or more colors associated with a subject, such as a representative color, a theme color, or a color palette, which is input by a user and used to control color characteristics of generated visual content.

The term “prompt sentence” refers to a text string that encodes generation instructions for a generative AI model, the text string being constructed from feature information, color attribute information, and optionally other contextual information, so as to guide the type and style of visual content to be generated.

The term “generative AI model” refers to a machine learning model that, in response to an input including a prompt sentence, automatically generates content such as an image, symbolic design, or other visual data, by executing learned parameterized transformations.

The term “abstract visual information” refers to visual data, such as an image or design, that represents concepts, moods, or stylized forms rather than realistic depictions, and that is generated based on input information and a prompt sentence by a generative AI model.

The term “image data” refers to digital data representing a visual image, including pixel values organized in one or more dimensions, which can be displayed on a display apparatus or further processed by an image-processing program.

The term “symbolic design data” refers to digital data representing a design composed of symbols, letters, monograms, or simplified graphical elements that may function as a logo, emblem, icon, or pattern.

The term “emotion analysis algorithm” refers to a computational procedure that processes input data, such as text, audio, or image data, to estimate an emotional state of a user by classifying or scoring affective characteristics.

The term “emotion information” refers to data indicating an estimated emotional state of a user, such as joy, sadness, neutrality, excitement, or calmness, which is output by an emotion analysis algorithm and used to control subsequent processing.

The term “color characteristics” refers to one or more properties of color in visual data, such as hue, saturation, brightness, contrast, or color distribution, which can be computationally adjusted by a processor.

The term “brightness characteristics” refers to properties of luminance or intensity of visual data, including overall brightness, local brightness, and contrast, which affect the perceived lightness or darkness of an image.

The term “visual expression” refers to the perceptible appearance of visual data, including composition, color, brightness, and stylistic features, as presented to a user on a display apparatus.

The term “communication network” refers to an arrangement of interconnected communication links and nodes, such as the Internet, local area networks, or wireless networks, that enables digital data transmission between a server and a terminal.

The term “pixel information” refers to data associated with individual picture elements of image data, including position, color values, and intensity values, which can be analyzed to derive patterns and material requirements.

The term “pattern data” refers to structured visual data derived from image data, in which resolution and color count are controlled so that individual pixels or units can serve as discrete elements in a design or craft pattern.

The term “material information” refers to data specifying one or more types and quantities of physical materials, such as threads, beads, paper, fabric, or other substrates, that are required to realize a physical item based on visual data or pattern data.

The term “creation instruction information” refers to data describing, in ordered steps, a procedure by which a user can create a product or activity article, the procedure being derived from visual data and pattern data.

The term “product” refers to a tangible or intangible item that incorporates visual content derived from abstract visual information, such as an article of clothing, an accessory, a printed item, or a digital asset.

The term “activity article” refers to a tangible item used in association with an activity or event, such as a decorative article, support article, or promotional article, that incorporates or is based on abstract visual information.

The term “handicraft work” refers to a manually produced item, such as embroidery, beadwork, knitting, or other hand-crafted article, that uses pattern data as a guide for placement of materials.

The term “identification image” refers to a visual representation associated with an entity or account in a communication service, such as an avatar, profile image, or icon, that can be generated from abstract visual information or pattern data.

The term “displayable format” refers to a data format that a terminal can render on a display apparatus, such as a raster image format, a vector graphic format, or a structured document format including embedded visual data.

In one embodiment, a server cooperates with one or more terminals to implement the claimed system. The server includes at least one processor, a memory storing executable programs and models, and a network interface. The terminal includes a processor, a display, input devices such as a touch panel, a microphone and a camera, and a communication interface. The user operates the terminal to provide input and to view generated visual information and related data.

The server executes an input handling program, an emotion analysis program, a prompt construction program, a generative AI invocation program, an image post-processing program, a pattern generation program, and a material and instruction generation program. The processor of the server stores these programs and associated data structures in the memory and executes the programs to realize the functions described below.

The terminal executes an interface program that presents input fields to the user and displays outputs received from the server. The terminal displays fields for multiple types of feature information, such as character attributes, shapes, or conceptual descriptions, and for color attribute information, such as a main color and sub-colors. The terminal optionally captures text comments, voice signals, and face images of the user. The terminal transmits the captured information to the server over a communication network using a structured data format, and the terminal receives results from the server and renders them on the display.

The server uses concrete hardware and software components to implement the invention. In one example, the server runs on a general-purpose computing platform including a multi-core central processing unit and a graphics processing unit. The server uses a network stack and a web framework to communicate with the terminal. The server uses a numerical computation library to process matrices and tensors, and uses an image-processing library to manipulate pixel data. The server also uses a machine learning framework to execute trained models, including a generative AI model and one or more neural networks for emotion analysis.

The server represents feature information and color attribute information by specific data structures stored in the memory. In one embodiment, the server stores feature information as a list of tokens or feature vectors, and the server stores color attribute information as tuples of numeric color values in a color space such as RGB or HSV. The server also maintains a context object that holds user identifiers, timestamps, emotion information, and references to generated visual information.

The server implements emotion analysis by applying an emotion analysis algorithm to at least one of text information, voice information, and image information. In one embodiment, the server uses a neural network-based emotion classifier. For text, the server uses a sequence model such as a transformer encoder or a bidirectional recurrent neural network trained on text labeled with emotion categories. For voice, the server extracts acoustic features such as Mel-frequency cepstral coefficients, pitch, and energy, and the server feeds these features to a neural network trained to output probabilities for multiple emotion classes. For image information, the server uses a convolutional neural network trained to classify facial expressions.

The server uses a specific loss function, such as cross-entropy loss, during training of the emotion analysis neural networks, and the server updates model weights using a gradient-based optimization algorithm. The server optionally performs data augmentation during training, such as random cropping, rotation, time stretching, and noise injection, to increase robustness. By training the emotion analysis models with such methods, the server achieves higher classification accuracy and robustness to variations in user input compared with simple rule-based sentiment analysis.

The server applies the emotion analysis algorithm at runtime to incoming user data. The server receives text comments from the terminal and passes tokenized text sequences to the text emotion model. The server receives audio samples and passes extracted acoustic feature vectors to the voice emotion model. The server receives face images and passes normalized image tensors to the facial expression model. The server obtains for each input modality a probability distribution over emotion classes stored as an array of real values. The server then combines these probability distributions according to predetermined rules, such as weighted averaging or majority voting, to determine final emotion information indicating a dominant emotion, such as joy, sadness, calmness, or excitement.

The server constructs a prompt sentence based on the feature information, the color attribute information, and optionally the emotion information. The server uses a prompt construction algorithm that maps the structured feature and color representations into a natural language string. The server may use templates, token ordering rules, and phrase insertion rules conditioned on the emotion information. Because the server operates on structured feature vectors and color tuples, the server can guarantee that all relevant attributes are encoded into the prompt sentence in a consistent way, which improves reproducibility and stability of the output of the generative AI model.

The server uses a generative AI model configured for image generation. In one embodiment, the server uses a diffusion-based model or a transformer-based image generation model trained on large-scale image-text pairs. The server supplies the prompt sentence as conditioning text to the generative AI model. The generative AI model converts the prompt sentence into an embedding vector, and the model uses this embedding to guide an iterative denoising process or a sequence generation process in a high-dimensional latent space. The server invokes the generative AI model through a model execution engine that supports batch processing, model sharding on multiple processing units, and caching of intermediate representations.

The server can use multiple architectures for the generative AI model. In one implementation, the server uses a text encoder, such as a transformer encoder, to compute a text embedding from the prompt sentence. The server provides this embedding to a denoising network, such as a U-Net with attention layers that operates on latent image tensors. The server runs a fixed number of denoising steps controlled by a scheduler that maps noise levels to step indices. The server decodes the final latent tensor into pixel values using a decoder network. The server may optionally use a variational autoencoder as the encoder-decoder pair. During training, the server or an external training node minimizes a loss function including reconstruction loss and guidance loss to align generated images with ground truth images described by text captions.

The server applies non-conventional control of the generative AI model by feeding back emotion information into the generative process. The server can perform this control in two ways. In a first mode, the server modifies the prompt sentence itself by inserting emotion descriptors, such as “bright and cheerful” for joy or “muted and calm” for sadness. In a second mode, the server passes the emotion information as an auxiliary conditioning vector to the generative AI model. In that case, the server embeds the emotion category into a continuous vector and concatenates it with the text embedding or injects it through attention conditioning. This dual conditioning on both semantic attributes and emotion attributes enables the generative AI model to produce images that are not only semantically aligned with the feature and color inputs but also visually aligned with the user's emotional state.

The server then performs image post-processing to adjust color characteristics or brightness characteristics of the image data or symbolic design data obtained from the generative AI model. The server uses an image-processing library to convert image data to a color space where brightness and saturation are explicitly represented, such as HSV or HSL. The server multiplies the brightness and saturation channels by factors selected based on the emotion information. For example, for joy or excitement, the server increases saturation and brightness, while for sadness or calmness, the server decreases saturation and brightness. Because the server applies these adjustments numerically to the pixel data according to rules derived from emotion probabilities, the server achieves consistent visual adaptation without manual tuning.

The server converts the adjusted abstract visual information into pattern data suitable for constrained displays, craft devices, or manufacturing systems. The server first resizes the image to a predetermined resolution, such as 32 by 32 pixels or 64 by 64 pixels, depending on a target use case. The server then performs color quantization to reduce the number of distinct colors to a predetermined number, such as 8 or 16. The server can use k-means clustering in color space or other vector quantization algorithms to assign each pixel to one of the cluster centroids. The resulting pattern data is stored as a grid of indices referencing a limited color palette.

The server analyzes the pattern data to derive material information for physical item creation. The server counts, for each palette index, the number of pixels assigned to that index. The server then maps each palette index to a material type, such as a thread color, a bead color, or a paint color, using a material mapping table stored in the memory. The server calculates the required quantity of each material based on a predetermined mapping between pixel count and unit material usage. For example, the server may determine that 100 pixels of a given color correspond to a specific length of thread or a specific number of beads. The server thus computes a material information set that associates each material type with a required quantity.

The server generates creation instruction information describing how to create a product or an activity article using the pattern data and the material information. In one embodiment, the server uses a rule-based template engine that assembles instruction sentences according to predefined patterns. The server selects templates based on a target item type, such as embroidery, bead art, or printing. The server combines parameters such as fabric size, stitch density, or bead spacing with the pattern data to generate stepwise instructions. In another embodiment, the server uses a text generation model conditioned on the pattern features and material information to produce procedural instructions. In both cases, the server structures the instructions as an ordered list of steps so that the user can follow them to produce a physical item.

In a concrete example, the user provides feature information indicating a “cat ear character” and color attribute information indicating “pink” as a main color. The user enters a comment expressing excitement. The terminal transmits this information to the server. The server analyzes the comment and determines emotion information corresponding to joy or excitement. The server constructs a prompt sentence such as “generate an abstract image of a cat-ear character with pink idol color and a joyful, energetic mood”. The server passes this prompt sentence to the generative AI model and obtains image data representing an abstract, pink, cat-themed design. The server adjusts the brightness and saturation upward to match the joyful emotion, downsamples and quantizes the image into a 32 by 32 pixel pattern with 8 colors, counts the pixels per color, maps each color to a material type such as colored beads, and calculates quantities. The server then generates instructions for creating a bead-art keychain based on the pattern. The terminal displays the resulting pattern, the material list, and the stepwise instructions.

In another example, the user provides a request such as “please generate a monogram of a blue bird”. The server treats this phrase as the primary feature information and also extracts color attribute information (blue) from the text. The server may determine emotion information as neutral if no strong affective signal is present. The server constructs a prompt sentence such as “please generate a monogram of a blue bird suitable for embroidery art with a calm blue tone”. The server obtains a monogram image from the generative AI model, converts it into a dot grid pattern, quantizes the colors to a limited palette, and computes material information for threads and fabric. The server produces creation instruction information for embroidery, and the terminal displays all outputs for the user.

The system provides technical improvements beyond mere automation of human mental processes. Because the server uses structured feature and color data, combines multi-modal emotion analysis outputs into prompt construction, and systematically converts high-resolution abstract visual information into low-resolution pattern data and material information, the server reduces manual design work and avoids repeated trial-and-error rendering. The specific data structures and processing pipeline enable the server to precompute and cache intermediate results, reduce network bandwidth by transmitting compact pattern data or references instead of full images when appropriate, and minimize redundant generative AI invocations by reusing embeddings for similar prompt sentences. These operations improve processing speed, reduce communication load, and enhance data consistency across sessions.

The server also improves accuracy and stability of the overall system. The emotion analysis neural networks, trained with explicit loss functions and augmented data, provide robust emotion information compared with heuristic methods. The dual conditioning of the generative AI model on feature-color attributes and emotion information allows the server to produce images with reduced variance in relevance and style. The systematic mapping from pattern data to material information ensures that the quantities of materials are derived from exact pixel counts rather than approximate human estimation, thereby reducing material waste and errors in production.

The server performs computations in a way that differs from conventional human workflows. The server does not merely digitize a manual process; instead, the server uses quantitative image analysis, vector quantization, pixel counting, and mapping to machine-readable material specifications. The server automatically generates structured pattern data and production instructions that conform to the constraints of displays and craft devices. Because the system defines explicit algorithms for data representation, transformation, and decision making, the system provides a repeatable and scalable pipeline that can be executed quickly and with low error, which is not achievable by manual design or by generic text-to-image generation alone.

Alternative implementations are possible within the scope of the claims. The server can use different generative AI model architectures, such as autoregressive image generation models or generative adversarial networks, as long as the server constructs a prompt sentence and obtains abstract visual information from the model. The server can use different color spaces for post-processing and quantization, such as CIELAB or YUV. The server can use alternative clustering algorithms for color quantization, such as hierarchical clustering or median cut. The server can deploy the emotion analysis models and the generative AI model on separate hardware nodes, and the server can communicate intermediate feature vectors between nodes. The terminal can be a head-mounted display, a kiosk, or an in-store tablet, and the server can adapt output formats accordingly, such as head-mounted overlays or kiosk printing formats.

In another variation, the server provides identification images for communication services. The server converts the adjusted abstract visual information into an icon-sized image and provides this as an identification image. The server also stores pattern data as metadata associated with the identification image so that downstream devices can reconstruct craft patterns from the icon if needed. In this way, the system connects digital identification images with physical handicraft works using a shared underlying pattern representation.

Through these embodiments and variations, the system realizes a concrete technological implementation of emotion-aware generative visual content creation, pattern conversion, and materials and instruction generation, and the system improves the operation of computers and networks used in these processes.

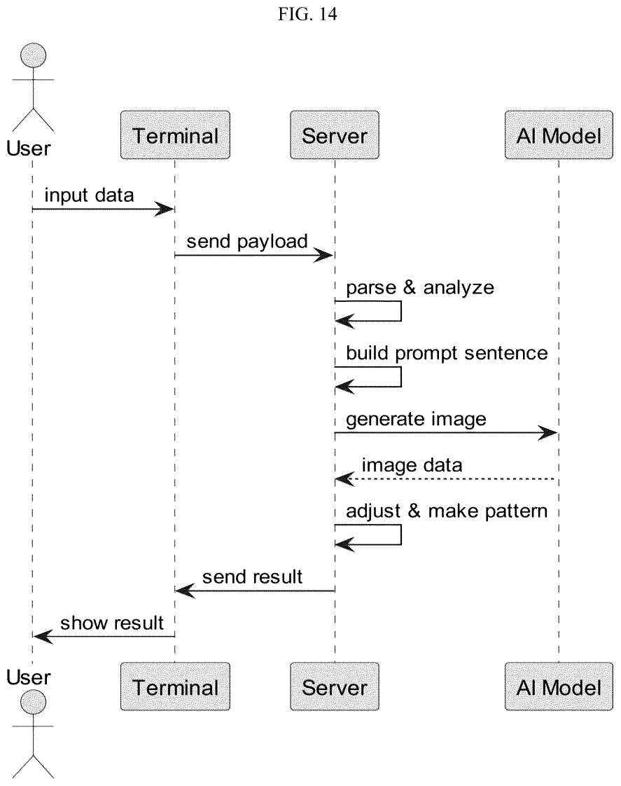

The following describes the processing flow using FIG. 14.

### Step 1

The terminal displays an input screen to the user. The terminal allocates UI components for feature information, color attribute information, free text comments, and optional media capture. The input of this step is an initial blank state; the output of this step is an active interface ready to accept user inputs.

### Step 2

The user inputs feature information and color attribute information through the terminal. The user types character attributes (for example, “cat ears”, “blue hair”), selects one or more colors (for example, “pink” as a main color), and optionally enters a free text comment and allows the terminal to capture voice or a face image. The input of this step is the displayed interface; the output is raw user data present in the terminal's memory.

### Step 3

The terminal structures the user data and prepares a transmission payload. The terminal converts text fields into a structured object, encodes color selections into numeric color values, and attaches encoded audio or image data if present. The terminal may perform local validation, such as checking that at least one feature and one color are provided. The input of this step is the raw user data; the output is a structured payload ready to be sent to the server.

### Step 4

The terminal transmits the structured payload to the server over a communication network. The terminal opens a secure connection, serializes the payload, and sends it using a network protocol. The input of this step is the structured payload in memory; the output is a network message delivered to the server.

### Step 5

The server receives the network message and parses the payload. The server reads the incoming data stream, decodes the serialized structure, and extracts fields such as feature information, color attribute information, text comments, and media data. The input of this step is the network message from the terminal; the output is a set of internal data structures representing the user inputs.

### Step 6

The server performs text preprocessing for emotion analysis. The server tokenizes the user's text comment, normalizes case, removes or marks punctuation, and converts tokens into numerical indices or embeddings. The input of this step is the raw text comment; the output is a numerical text feature representation suitable for an emotion analysis algorithm.

### Step 7

The server performs audio preprocessing for emotion analysis when audio is present. The server decodes the audio stream, applies framing and windowing, and computes acoustic features such as Mel-frequency cepstral coefficients, pitch contours, and energy statistics. The input of this step is an encoded audio signal; the output is a time-series of audio feature vectors.

### Step 8

The server performs image preprocessing for emotion analysis when a face image is present. The server decodes the image, detects and crops the face region, resizes the face region to a fixed resolution, normalizes pixel values, and arranges the pixels into a tensor. The input of this step is the raw face image; the output is a normalized image tensor.

### Step 9

The server executes emotion analysis on text, audio, and image data. The server inputs the text feature representation into a trained text emotion model, inputs the audio feature vectors into a voice emotion model, and inputs the image tensor into a facial expression model. The server computes emotion probability distributions for each modality using neural network inference. The input of this step is the set of preprocessed features; the output is one or more probability vectors representing candidate emotions.

### Step 10

The server fuses the modality-specific emotion results to determine final emotion information. The server applies a predefined rule, such as weighted averaging or majority voting, to the probability vectors, and selects the dominant emotion class accordingly. The input of this step is the set of probability vectors for each modality; the output is emotion information indicating a final emotion label and optionally a confidence score.

### Step 11

The server transforms feature information and color attribute information into internal representations for prompt construction. The server normalizes feature strings, maps them to controlled vocabularies or embedding vectors, and converts color values to a standard color space and symbolic names. The input of this step is the raw feature and color text; the output is a structured representation of semantic features and color attributes.

### Step 12

The server constructs a base prompt sentence from the structured feature and color representations. The server applies template rules to place feature descriptors and color descriptors into a coherent natural language string. The input of this step is the structured feature/color representation; the output is a base prompt sentence without emotion terms.

### Step 13

The server augments the base prompt sentence with emotion-dependent modifiers. The server examines the final emotion information and selects descriptive phrases corresponding to that emotion, such as “bright and cheerful” for joy or “muted and calm” for sadness. The server inserts these phrases into the base prompt sentence at predetermined positions. The input of this step is the base prompt sentence and the emotion information; the output is a final prompt sentence tailored to the user's emotional state.

### Step 14

The server selects parameters for the generative AI model based on the type of requested visual content. The server determines whether to generate an abstract image, a symbolic monogram, or a profile icon and sets parameters such as image resolution, number of samples, and style configuration. The input of this step is the type of requested output and system configuration; the output is a configured parameter set for the generative AI model.

### Step 15

The server inputs the final prompt sentence and the model parameters into the generative AI model. The server encodes the prompt sentence into an embedding vector and provides it, together with any auxiliary emotion vector, to the generative model's inference routine. The input of this step is the final prompt sentence and configuration parameters; the output is one or more latent visual representations generated by the model.

### Step 16

The server decodes the latent visual representations into image data or symbolic design data. The server uses a decoder network or a mapping function to convert latent tensors into pixel grids, and formats the resulting grids as image files or design objects. The input of this step is the latent representations from the generative AI model; the output is raw abstract visual information in a displayable digital format.

### Step 17

The server performs color space conversion on the raw abstract visual information. The server converts pixel data from a base color space, such as RGB, into a color space that separates luminance and chroma, such as HSV or HSL, to facilitate further adjustments. The input of this step is the generated image data; the output is an image representation in a color space suitable for tone manipulation.

### Step 18

The server adjusts color and brightness characteristics according to the emotion information. The server applies numerical scaling to brightness and saturation channels, modifying pixel values to increase or decrease vibrancy and lightness. The input of this step is the color-space-converted image and the emotion information; the output is adjusted abstract visual information whose tone reflects the user's emotional state.

### Step 19

The server resizes the adjusted abstract visual information to a predetermined pattern resolution. The server computes scaling factors and applies resampling to reduce the image dimensions to pattern sizes such as 32 by 32 or 64 by 64 pixels. The input of this step is the adjusted abstract visual information; the output is a low-resolution image suitable for pattern generation.

### Step 20

The server performs color quantization on the low-resolution image to produce a limited palette. The server applies a clustering algorithm in color space to group pixels into a specified number of color clusters, and replaces each pixel's color with the nearest cluster centroid. The input of this step is the low-resolution image; the output is a pattern image with a fixed, small set of color values.

### Step 21

The server generates pattern data from the quantized image. The server maps each pixel's color to an index in a palette table and constructs a grid of palette indices as a pattern representation. The input of this step is the quantized image; the output is pattern data defined as a matrix of discrete color indices.

### Step 22

The server calculates material information based on the pattern data. The server counts the number of occurrences of each palette index in the matrix, and uses a conversion rule to map pixel counts to material types and quantities, such as lengths of thread or numbers of beads. The input of this step is the pattern matrix and a material mapping table; the output is a list of material entries specifying type and required quantity.

### Step 23

The server generates creation instruction information using the pattern data and the material information. The server selects an instruction template corresponding to a target product type and fills the template with pattern size, color order, and material quantities, forming an ordered list of steps that describe a production procedure. The input of this step is the pattern data, material information, and product type; the output is structured textual instructions.

### Step 24

The server assembles a response payload containing the adjusted abstract visual information, the pattern data, the material information, the creation instruction information, and the final prompt sentence. The server serializes these components into a structured format ready for transmission. The input of this step is the set of generated and derived data objects; the output is a composite response object.

### Step 25

The server transmits the composite response object to the terminal over the communication network. The server initiates a reply on the existing connection or opens a new transmission, ensuring that all data segments are delivered and acknowledged. The input of this step is the composite response object in the server's memory; the output is a network message containing the result of the generation and analysis processes.

### Step 26

The terminal receives the network message and parses the composite response object. The terminal decodes the serialized structure, extracts the image data, pattern matrix, material list, instruction text, and the prompt sentence, and stores them in local memory. The input of this step is the received network message; the output is decomposed result data accessible to the terminal's interface program.

### Step 27

The terminal renders the adjusted abstract visual information on the display. The terminal decodes the image data into a bitmap or equivalent internal format, scales it to fit a display region, and updates the display buffer. The input of this step is the abstract visual information; the output is a visual presentation of the generated image to the user.

### Step 28

The terminal displays the pattern data, material information, and creation instruction information in an interactive layout. The terminal converts the pattern matrix into a graphical grid, displays the material list as a checklist or table, and presents the instructions as an ordered text list. The input of this step is the pattern matrix, material list, and instructions; the output is a combined interface allowing the user to review and follow the guidance.

### Step 29

The user reviews the displayed information and decides on further action. The user may request regeneration by adjusting feature or color inputs, may save the visual information to local storage, or may begin physical creation of a product using the provided pattern and materials. The input of this step is the rendered outputs on the terminal; the output is a new user command or an initiation of real-world use of the generated content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

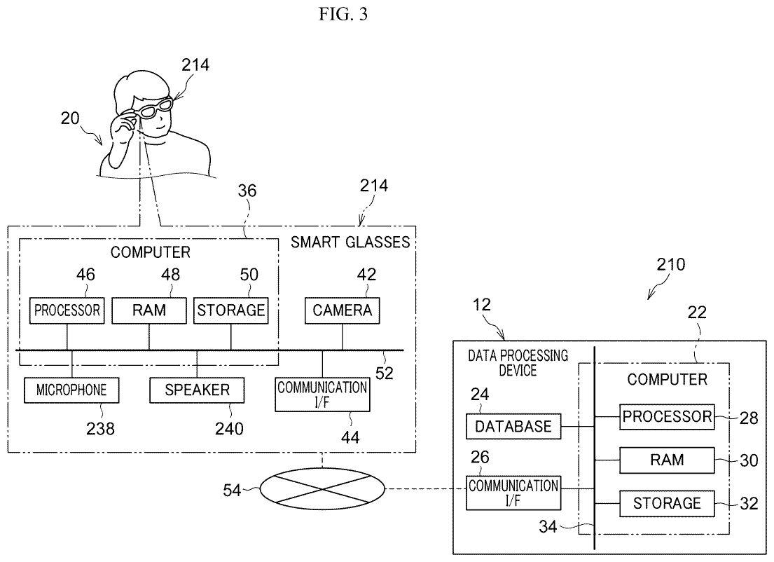

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

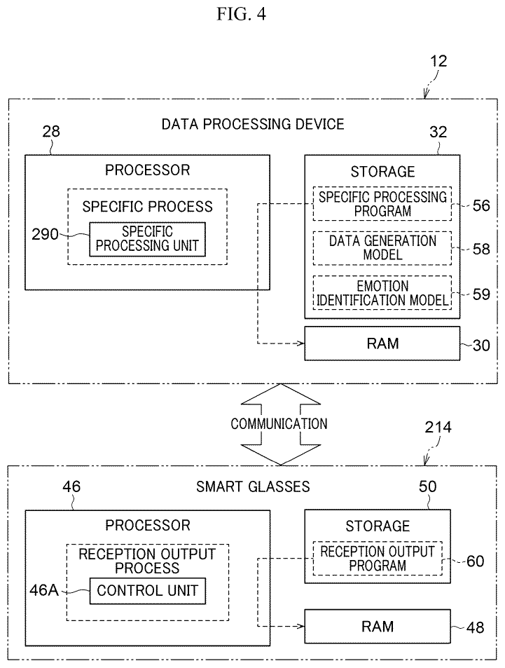

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

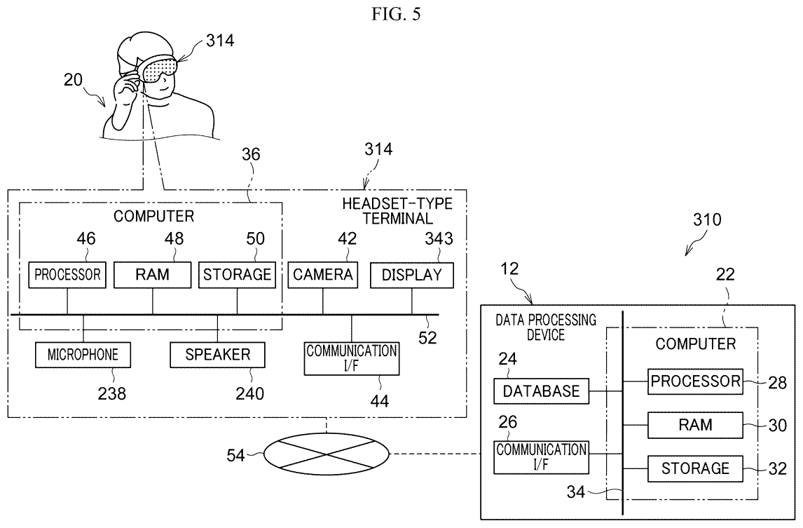

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

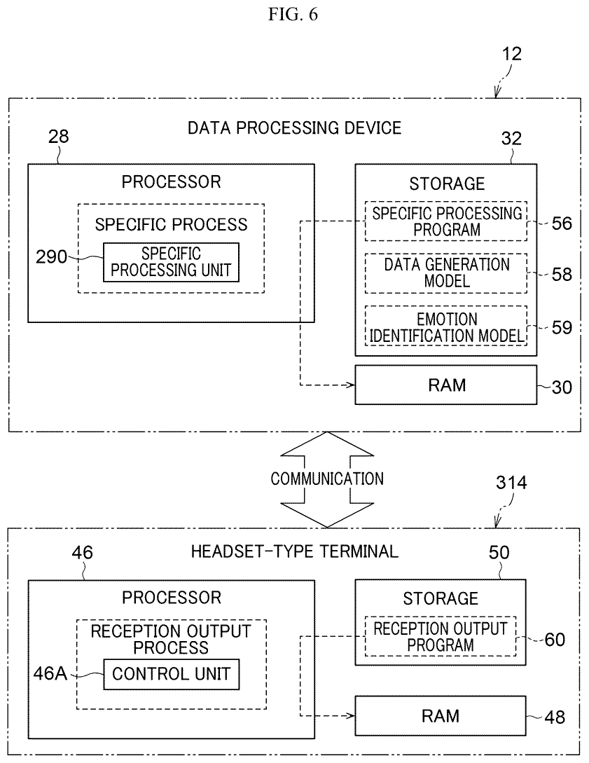

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

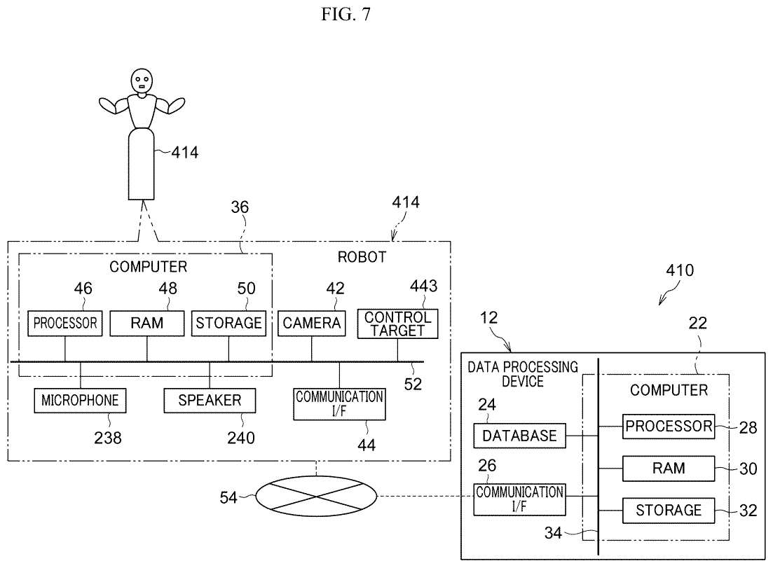

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

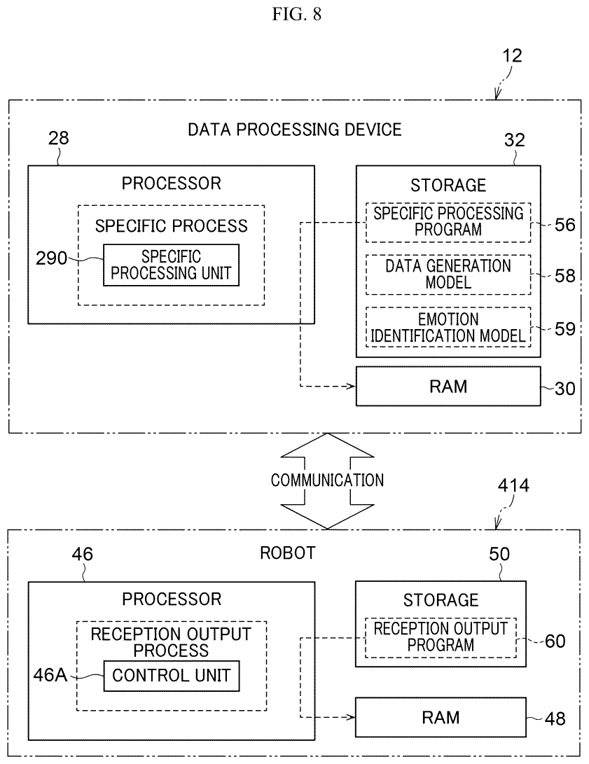

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

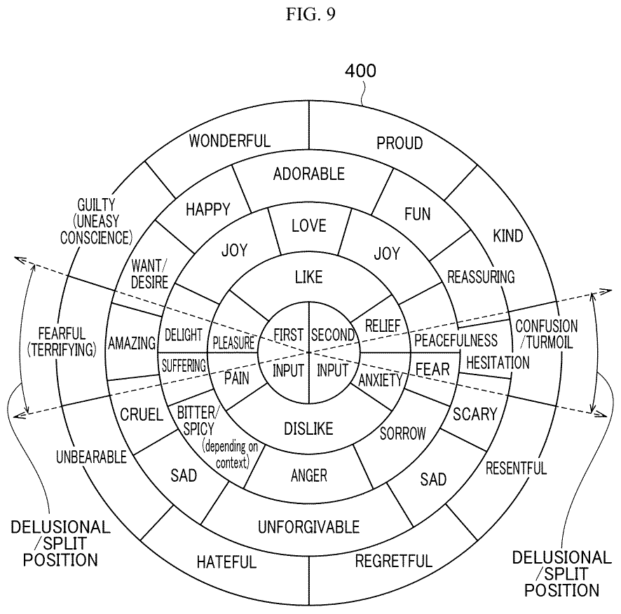

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

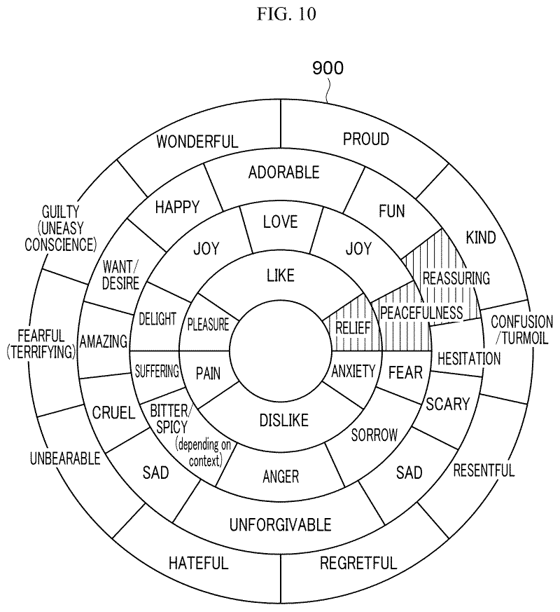

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive a plurality of information inputs from a user, the plurality of information inputs including attribute information and color information, and convert the attribute information and the color information into structured information,
apply a natural language processing algorithm to the structured information to perform segmentation into linguistic units and extraction of important linguistic units, and generate generation description information based on a result of the extraction,
create a prompt sentence by using the generation description information and the color information, embed the generation description information into the prompt sentence, and
input the prompt sentence to a generative artificial intelligence model to cause the generative artificial intelligence model to generate content data comprising visual information or character information,
apply an emotion analysis algorithm to at least one of the attribute information and the content data in order to analyze an emotional state of the user, and dynamically adjust at least one of a color tone and a component of the content data based on a result of the analysis and the color information, and
transmit the adjusted content data to a user information processing terminal and convert the adjusted content data into a format displayable or outputtable by the user information processing terminal.

### Supplementary 2

The system according to supplementary 1,
wherein the processor is configured to
generate presentation instruction information including at least one of a concrete layout method and a production procedure of a decorative article based on the adjusted content data and the structured information, and present the presentation instruction information to the user information processing terminal.

### Supplementary 3

The system according to supplementary 1,
wherein the processor is configured to
reconstruct, when the content data comprises visual information, the visual information as a sequence of pixel information to output the visual information as low-resolution graphic information, and provide the low-resolution graphic information in a format usable as an identification image on a communication network.

### Application Example 1

### Supplementary 1

A system comprising a processor, a memory, and a communication interface,
wherein the processor is configured to
receive, from a terminal operated by a user, a plurality of input information items including attributes related to an appearance and a personality of a character and attributes related to a color scheme, and acquire the plurality of input information items as structured data,
perform normalization processing and attribute completion processing on the structured data, including converting the attributes related to the color scheme into standardized color classification information, and integrating the attributes related to the appearance and the personality of the character into descriptive information,
generate, on the basis of the descriptive information and the color classification information, a natural-language prompt sentence for generating visual content, in accordance with predetermined sentence-structure rules and style conditions, and input the generated prompt sentence to a generative AI model,
obtain visual content data output from the generative AI model, perform post-processing on the visual content data including adjusting at least one of a pixel count, an encoding scheme, and a storage format of the visual content data, and transmit the post-processed visual content data to the terminal via the communication interface,
control the terminal to display the visual content data on a display device of the terminal, store the visual content data in association with the prompt sentence and the plurality of input information items as history information, and present, on the terminal, operation procedures for sharing the visual content data with another user, and
apply an emotion analysis algorithm to emotion-related input information from the user and to the visual content data, and dynamically adjust, on the basis of an analysis result obtained by the emotion analysis algorithm, at least a description related to a color tone and a description related to a style contained in the prompt sentence.

### Supplementary 2

The system according to supplementary 1,
wherein the processor is configured to
generate, on the basis of the visual content data and the prompt sentence, a plurality of work procedures relating to a method for producing at least one of a decorative article and a display article using the visual content data, and present the plurality of work procedures to the user via the terminal.

### Supplementary 3

The system according to supplementary 1,
wherein the processor is configured to
convert the visual content data output from the generative AI model into pixel-level array data, reconstruct the pixel-level array data as simplified graphic data, combine the simplified graphic data with short text information to generate identification display data, and provide the identification display data to the terminal in a format usable as an identification image in a communication network service.

### Example 2

### Supplementary 1

A system comprising a processor,
wherein the processor is configured to
receive, via a terminal, a plurality of pieces of information regarding characteristics and colors of a target from a user, generate a prompt sentence in a natural language based on the plurality of pieces of information, and convert the prompt sentence into a structured prompt suitable for input to a generative AI model,
apply a natural language processing algorithm to the prompt sentence to extract keywords and attributes, and convert the prompt sentence into numerical data by generating an input embedding vector for the generative AI model based on an extraction result,
input the embedding vector to the generative AI model and generate image data representing an abstract visual expression corresponding to the user input by executing iterative numerical computation including matrix computation and nonlinear computation in the generative AI model,
adjust a color tone of the generated image data based on an analysis result of a sentiment analysis algorithm that analyzes a sentiment of the user, and
encode the color-tone-adjusted image data into a predetermined image format and provide the encoded image data in a format transmittable to the terminal via a network.

### Supplementary 2

The system according to supplementary 1,
wherein the processor is configured to
generate, based on the prompt sentence and feature information regarding the generated abstract visual expression, stepwise operation instructions representing creation procedures of a decorative article using the abstract visual expression, and present the stepwise operation instructions to the user via the terminal.

### Supplementary 3

The system according to supplementary 1,
wherein the processor is configured to
convert the generated abstract visual expression into a pixel-level pattern, output the pixel-level pattern as a low-resolution dot representation, and provide the low-resolution dot representation to the terminal in a format usable as an identification image in a communication network service.

Application Example 2

### Supplementary 1

A system comprising a processor,
wherein the processor is configured to
receive, via a terminal, multiple types of feature information and color attribute information from a user, and construct, on the basis of the feature information and the color attribute information, a prompt sentence as a generation instruction text,
transmit input data including the prompt sentence to a generative artificial intelligence model and acquire abstract visual information in a form of image data or symbolic design data from the generative artificial intelligence model,
apply an emotion analysis algorithm to text information, voice information, or image information acquired from the user so as to perform emotion estimation processing and specify emotion information indicating an emotional state of the user,
change, in accordance with the emotion information, at least one of content of the prompt sentence supplied to the generative artificial intelligence model and color characteristics or brightness characteristics of the image data or the symbolic design data acquired from the generative artificial intelligence model, and adjust the abstract visual information such that the abstract visual information becomes a visual expression adapted to the emotional state of the user, and
transmit the adjusted abstract visual information to the terminal via a communication network and provide the adjusted abstract visual information to the terminal in a displayable format.

### Supplementary 2

The system according to supplementary 1,
wherein the processor is configured to
analyze pixel information of the abstract visual information, calculate material information including a material type and a required quantity for each color on the basis of a number of pixels for each color, generate creation instruction information describing, as stepwise procedures, production processes for creating a product or an activity article using the abstract visual information, and present the material information and the creation instruction information to the terminal.

### Supplementary 3

The system according to supplementary 1,
wherein the processor is configured to
reduce the abstract visual information to a predetermined number of pixels, quantize a number of colors of the abstract visual information to be equal to or less than a predetermined number so as to generate pattern data on a pixel-by-pixel basis, and convert and provide the pattern data in a data format usable as an identification image in a communication service or as a pattern for a handicraft work.

What is claimed is:

1. A system comprising:
circuitry configured to:
acquire, via a communication interface coupled to a packet-switched network, structured attribute data and color parameter data transmitted from a terminal device;
construct a prompt data structure based on the structured attribute data and the color parameter data, and transmit the prompt data structure to a generative neural network model to obtain generated image data;
apply an emotion analysis model to at least one of the structured attribute data and the generated image data to determine an emotional state;
adjust at least one color characteristic of the generated image data on the basis of the determined emotional state and the color parameter data to produce adjusted image data; and
transmit the adjusted image data to the terminal device via the packet-switched network.

2. The system according to claim 1, wherein the circuitry is configured to convert the structured attribute data and the color parameter data into a normalized representation by mapping synonymous attribute expressions to canonical tokens using a lookup table and by converting color values to a standardized color classification.

3. The system according to claim 2, wherein the circuitry is configured to perform attribute completion processing on the normalized representation by evaluating correlation rules that associate combinations of existing canonical tokens with inferred additional tokens, thereby enriching the structured attribute data prior to prompt construction.

4. The system according to claim 3, wherein the circuitry is configured to apply a natural language processing algorithm to the enriched structured attribute data to perform segmentation into linguistic units and extraction of important linguistic units on the basis of frequency measures and syntactic patterns, and generate generation description data based on the extracted important linguistic units.

5. The system according to claim 4, wherein the circuitry is configured to construct the prompt data structure by selecting a prompt template from a plurality of stored prompt templates on the basis of a content type indicator, inserting the generation description data and the standardized color classification into designated positions within the selected prompt template, and embedding structural delimiters that guide an attention mechanism of the generative neural network model.

6. The system according to claim 1, wherein the emotion analysis model comprises a neural network classifier that receives feature data derived from at least one of the structured attribute data and the generated image data and outputs a probability distribution over a plurality of emotion categories, and wherein the circuitry is configured to select the emotional state corresponding to a highest probability among the plurality of emotion categories.

7. The system according to claim 6, wherein the circuitry is configured to receive multimodal input data from the terminal device comprising at least two of text data, audio data, and image data of the user, apply separate emotion classifiers to each modality to obtain modality-specific probability distributions, and fuse the modality-specific probability distributions according to a predetermined combination rule to determine the emotional state.

8. The system according to claim 7, wherein the emotion categories are arranged according to an emotion map that positions emotions along dimensions corresponding to valence and arousal, and wherein the circuitry is configured to map the emotional state to a coordinate on the emotion map and derive the at least one color characteristic adjustment from a region of the emotion map corresponding to the coordinate.

9. The system according to claim 1, wherein the circuitry is configured to generate presentation instruction data comprising at least one of a layout specification and a stepwise production procedure for creating a physical article using the adjusted image data, and transmit the presentation instruction data to the terminal device.

10. The system according to claim 9, wherein the circuitry is configured to analyze feature regions of the adjusted image data by performing contour detection and color clustering to identify a main subject region and dominant color blocks, and compute spatial arrangement parameters including a bounding box, margin values, and scaling factors for placement of the main subject region onto a substrate template corresponding to the physical article.

11. The system according to claim 10, wherein the physical article comprises a decorative fan article associated with a character, and wherein the stepwise production procedure specifies at least a printing size, a cutting contour derived from the contour detection, and an attachment method for affixing the adjusted image data to a surface of the decorative fan article.

12. The system according to claim 1, wherein the circuitry is configured to downsample the adjusted image data to a reduced resolution grid, quantize color values of the downsampled image data to a limited palette comprising a predetermined number of colors, and output a pixel-level pattern as low-resolution graphic data.

13. The system according to claim 12, wherein the circuitry is configured to encode the low-resolution graphic data in a compact image format and transmit the encoded low-resolution graphic data to the terminal device in a format usable as an identification image in a communication network service.

14. The system according to claim 1, wherein the circuitry is configured to adjust the at least one color characteristic by converting pixel values of the generated image data from a first color space to a second color space that separates luminance and chroma components, modifying at least one of a hue, a saturation, and a brightness component on the basis of the determined emotional state, and converting the modified pixel values back to the first color space.

15. The system according to claim 14, wherein the circuitry is configured to count a number of pixels assigned to each color in the adjusted image data after quantization, map each color to a material type using a material mapping table, and calculate a required quantity of each material type on the basis of the number of pixels and a predetermined conversion factor to generate material information for creation of a physical article.

16. The system according to claim 1, wherein the circuitry is configured to store the adjusted image data in a storage device in association with the prompt data structure, the structured attribute data, the color parameter data, and the determined emotional state as a linked record, and retrieve the linked record on the basis of a retrieval condition for reuse in subsequent image generation.

17. The system according to claim 16, wherein the circuitry is configured to determine that newly received structured attribute data matches a previously stored linked record on the basis of a similarity threshold applied to the structured attribute data, and reuse the prompt data structure from the previously stored linked record while applying only a color characteristic adjustment corresponding to a newly determined emotional state, thereby avoiding re-execution of the generative neural network model.

18. A system comprising:
circuitry configured to:
acquire, via a communication interface coupled to a packet-switched network, structured attribute data and color parameter data from a terminal device, convert the structured attribute data into a normalized representation by mapping attribute expressions to canonical tokens, and convert the color parameter data into a standardized color classification;
apply a natural language processing algorithm to the normalized representation to perform segmentation into linguistic units and extraction of important linguistic units, and generate generation description data;
construct a prompt data structure by inserting the generation description data and the standardized color classification into a prompt template, encode the prompt data structure into an input embedding vector using a Transformer-based text encoder comprising self-attention layers that compute attention weights via scaled dot-product attention and softmax normalization, and transmit the input embedding vector to a generative neural network model comprising a denoising network that iteratively refines a latent tensor through a sequence of matrix computations and nonlinear activations conditioned on the input embedding vector to obtain generated image data;
apply an emotion analysis model comprising a neural network classifier to at least one of the structured attribute data and the generated image data to output a probability distribution over a plurality of emotion categories and determine an emotional state;
convert pixel values of the generated image data from a first color space to a second color space separating luminance and chroma, adjust at least one of a hue, a saturation, and a brightness on the basis of the determined emotional state and the color parameter data, and convert the adjusted pixel values back to the first color space to produce adjusted image data;
store the adjusted image data in a storage device in association with the prompt data structure and the emotional state as a linked record; and
transmit the adjusted image data to the terminal device via the packet-switched network.

19. The system according to claim 18, wherein the circuitry is configured to downsample the adjusted image data to a reduced resolution grid, quantize color values to a limited palette, output a pixel-level pattern as low-resolution graphic data usable as an identification image in a communication network service, and generate presentation instruction data comprising a stepwise production procedure for creating a decorative article using the adjusted image data.

20. A method performed by circuitry of a server coupled to a packet-switched network via a communication interface, the method comprising:
acquiring, via the communication interface, structured attribute data and color parameter data transmitted from a terminal device;
constructing a prompt data structure based on the structured attribute data and the color parameter data, and transmitting the prompt data structure to a generative neural network model to obtain generated image data;
applying an emotion analysis model to at least one of the structured attribute data and the generated image data to determine an emotional state;
adjusting at least one color characteristic of the generated image data on the basis of the determined emotional state and the color parameter data to produce adjusted image data; and
transmitting the adjusted image data to the terminal device via the packet-switched network.
